(19) United States
(12) Patent Application Publication
(10) Pub. No.: US 2016/0267533 A1
(43) Pub. Date: Sep. 15, 2016

(54) Marketing Management System

(71) Applicant: Nits Solutions, Inc., Farmington Hills, MI (US)

(72) Inventors: Sanjay Seth, Novi, MI (US); Neetu Seth, Novi, MI (US)

(73) Assignee: Nits Solutions, Inc., Farmington Hills, MI (US)

(21) Appl. No.: 15/061,076

(22) Filed: Mar. 4, 2016

Related U.S. Application Data
(60) Provisional application No. 62/133,199, filed on Mar. 13, 2015.

(51) Int. Cl. G06Q 30/02

(52) U.S. Cl. CPC G06Q 30/0255

(57) ABSTRACT

A method includes receiving transactions and storing the transactions in non-transitory memory and associating customer metrics with each transaction. The method further includes receiving a selection of one or more customer metrics, and determining one or more customers associated with the received selection of the one or more customer metrics and receiving one or more marketing campaigns over a network from a remote processing device. The method further includes receiving from the seller, a selection of a marketing campaign of the received one or more marketing campaigns, and modifying the selected marketing campaign. The method also includes transmitting the modified selected marketing campaign over a network to a remote entity. The selected marketing campaign may be modified by adding seller information of the seller to the selected marketing campaign and tailoring an offer of the marketing campaign based on the selection of one or more customer metrics.

### CROSS REFERENCE TO RELATED APPLICATIONS

This U.S. patent application claims priority under 35 U.S.C. §119(e) to U.S. Provisional Application 62/133,199, filed on Mar. 13, 2015, which is hereby incorporated by reference in its entirety.

### TECHNICAL FIELD

This disclosure relates to a marketing management system for managing marketing and marketing campaigns of wholesale goods to customers.

### BACKGROUND

Wholesaling or distributing goods or merchandise typically includes selling goods or merchandise to retailers—industrial, commercial, institutional, or other professional business users—or to other wholesalers and related sub coordinated services. In some examples, wholesalers or distributors sell the goods or merchandise to one layer of intermediary customers before reaching an end customer. In other examples, the wholesalers or distributors sell the goods or merchandise to multiple layers of intermediary customers before the goods or merchandise reach the end customer. Sometimes, the wholesalers monitor the goods being sold to the different intermediary customers. Maintaining a record of such information may be cumbersome and difficult due to the large amount of information.

### SUMMARY

One aspect of the disclosure provides a user device that includes a display, a computing device, and non-transitory memory. The computing device is in communication with the display, and the non-transitory memory is in communication with the computing device. The non-transitory memory stores instructions that when executed on the computing device cause the computing device to perform operations of a method. The method include receiving transactions at a data processing device, storing the transactions in non-transitory memory in communication with the data processing device and associating, at the data processing device, customer metrics with each transaction. Each transaction includes sale information between a seller and a customer. Each customer metric includes a quantitative representation indicative of a transactional variable of a transaction between the seller and a customer. The method further includes receiving, at the data processing device, a selection of one or more customer metrics, determining, at the data processing device, one or more customers associated with the received selection of the one or more customer metrics and receiving, at the data processing device, one or more marketing campaigns over a network from a remote processing device. Each marketing campaign includes information related to goods or services offered by the seller. The method further includes receiving, at the data processing device from the seller, a selection of a marketing campaign of the received one or more marketing campaigns, modifying, at the data processing device, the selected marketing campaign and transmitting the modified selected marketing campaign from the data processing device over the network to a remote entity. The selected marketing campaign may be modified by adding seller information of the seller to the selected marketing campaign and tailoring an offer of the marketing campaign based on the selection of one or more customer metrics.

Implementations of the disclosure may include one or more of the following optional features. In some implementations, the method includes at least one of a customer name, a customer address, customer information, a customer type, a customer status, or a transaction type. The customer status may include an active status, an inactive status, or a prospective status. The active status corresponds to a customer having an active associated purchase history within a threshold period of time, the inactive status corresponds to a customer having an inactive associated purchase history for the first threshold period of time, and the prospective status corresponds to a customer having no associated purchase history. Each transaction may include information of at least one of a service or merchandise of the seller to a customer.

One or more marketing campaigns may include at least one of a direct mail marketing campaign, an email marketing campaign, a phone call marketing campaign, a flyer marketing campaign, or a survey marketing campaign. The seller information may include at least one of a seller name, a seller logo, an image, a coupon, an offer, or text information. The method may include generating a report based on the customer metrics and the modified selected marketing campaign transmitted from the data processing device over the network to the remote entity. Generating the report may further include generating and displaying on an electronic display in communication with the data processing device an interactive report that provides cascading information for a customer type, a customer status, and the selected marketing campaign. Generating the report may further include generating a table or graphical illustration illustrating a sales trend over a period of time based on the selected marketing campaign. The method may further include receiving, at the data processing device over the network from the remote entity, customer feedback associated with the selected marketing campaign.

Another aspect of the disclosure provides a system for implementing a marketing management system. The system includes a display, a computing device in communication with the display, and non-transitory memory in communication with the display. The non-transitory memory stores instructions that when executed on the computing device cause the computing device to performs operations of a method. The method includes receiving, at the data processing device from a remote processing device of a seller over a network, a set of seller records corresponding to transactions between a seller and customers of the seller, storing the seller records in non-transitory memory in communication with the data processing device, and associating, at the data processing device, customer metrics with the transactions. Each customer metric includes a quantitative representation indicative of a transactional variable of a transaction between the seller and a customer. The method further includes analyzing the seller records stored in the non-transitory memory, using the data processing device, based on the customer metrics and seller information of the seller stored in the non-transitory memory, receiving, at the data processing device, a user input including instructions to generate one or more marketing campaigns and receiving, at the data processing device from the remote processing device of the seller, a selection of a marketing campaign from the one or more marketing campaigns. The method further includes modifying, at the data processing device, the selected marketing campaign based on seller information of the seller received from the remote data processing device and one or more customers associated with the received selection of the one or more metrics by associating the seller information with the marketing campaigns and transmitting the modified marketing campaign from the data processing device to the remote processing device.

In some implementations, the customer metrics include at least one of a customer name, a customer address, customer information, a customer type, a customer status, or a transaction type. The customer status may include an active status, an inactive status, or a prospective status. The active status corresponds to a customer having an active associated purchase history within a first threshold period of time, the inactive status corresponds to a customer having an inactive associated purchase history for the first threshold period of time, and the prospective status corresponds to a customer having no associated purchase history. Each transaction includes information of at least one of a service or merchandise of the seller to a customer. One or more marketing campaigns may include at least one of a direct mail marketing campaign, an email marketing campaign, a phone call marketing campaign, a flyer marketing campaign, or a survey marketing campaign. The seller information may include at least one of a seller name, a seller logo, an image, a coupon, an offer, or text information.

In some examples, the method includes generating a report based on the customer metrics and the modified selected marketing campaign. Generating the report further includes generating and displaying on an electronic display in communication with the data processing device an interactive report that provides cascading information for a customer type, a customer status, and the selected marketing campaign. Generating the report may further include generating a table or graphical illustration illustrating a sales trend over a period of time based on the selected marketing campaign. The method may further include receiving, at the data processing device over the network from the remote processing device of the seller, customer feedback associated with the selected marketing campaign.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary marketing management system.

FIGS. 2A and 2B are schematic views of exemplary marketing management systems.

FIG. 3 is a schematic view of a screen displaying an exemplary screenshot of setting up a direct mail marketing campaign.

FIG. 4 is a schematic view of a screen displaying an exemplary screenshot of an email marketing campaign.

FIG. 5 is a schematic view of a screen displaying an exemplary screenshot of setting up a phone call marketing campaign.

FIG. 6 is a schematic view of a screen displaying an exemplary screenshot of a flyer marketing campaign.

FIG. 7 is a schematic view of a screen displaying an exemplary screenshot of a survey marketing campaign.

FIG. 8 is a schematic view of a screen displaying an exemplary screenshot of setting up a survey marketing campaign.

FIG. 9 is a schematic view of a screen displaying an exemplary screenshot of a marketing campaign.

FIG. 10 is a schematic view of an exemplary arrangement of operations for a user logging in to the marketing management system.

FIG. 11 is a schematic view of a screen displaying an exemplary coupon and benefit effectiveness search and results.

FIG. 12 is a schematic view of an exemplary arrangement of operations for a method of tailoring a template marketing campaign.

FIG. 13 is a schematic view of an exemplary arrangement of operations for a method of generating a template marketing campaign

FIG. 14 is a schematic view of an example computing device executing any systems or methods described herein.

Like reference symbols in the various drawings indicate like elements.

### DETAILED DESCRIPTION

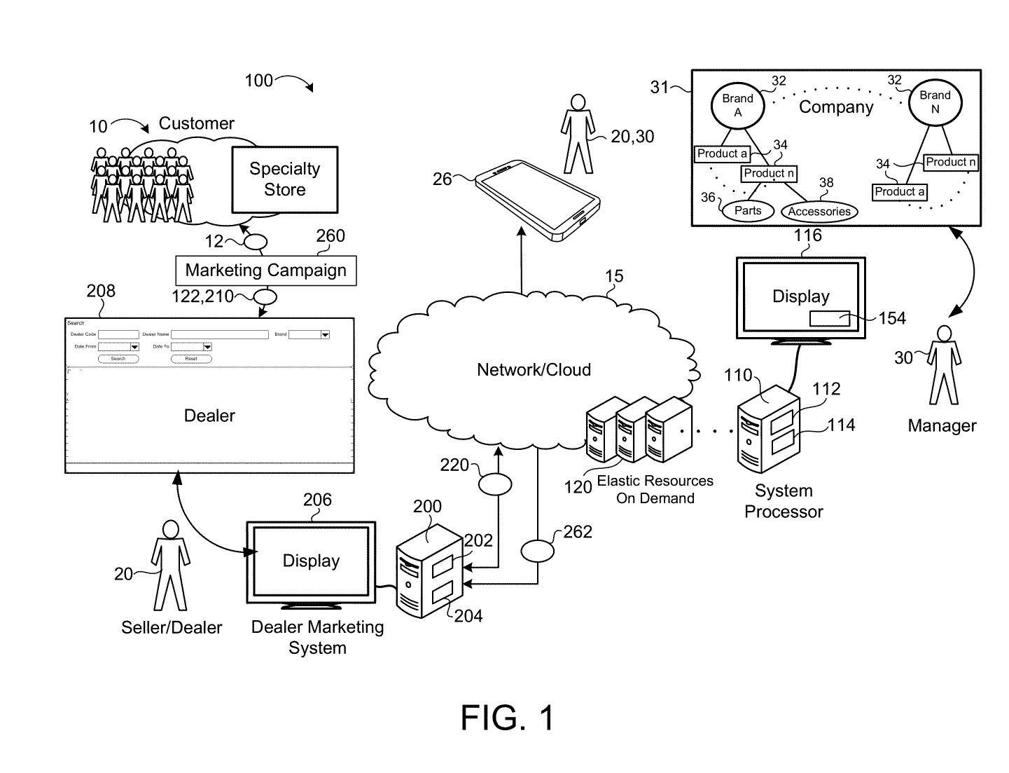

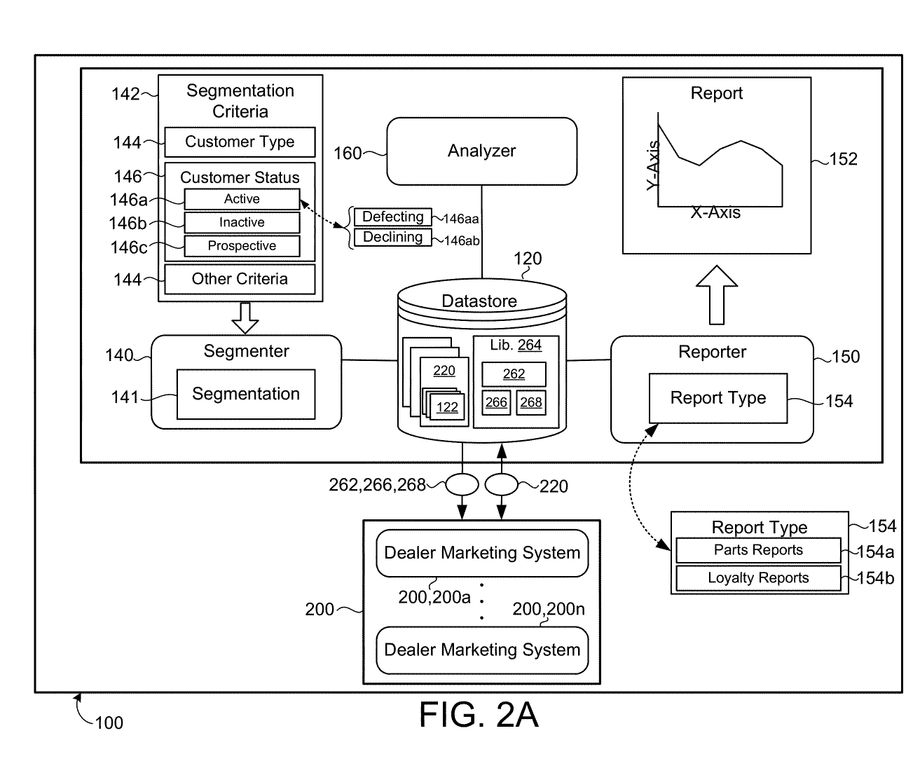

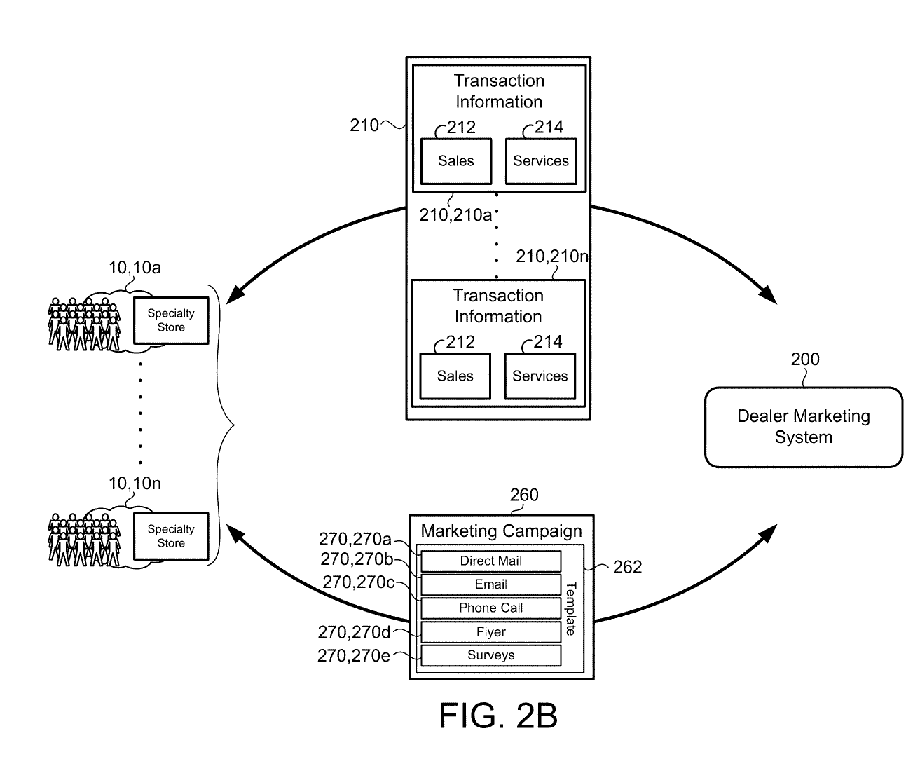

Referring to FIGS. 1-2B, in some implementations, a marketing management and execution system 100 allows sellers 20 (e.g., dealers) and managers 30 to setup and execute various marketing campaigns to their customers 10 (and sometimes the seller 20) relating to goods/merchandise 31 and services that the sellers 20 provide to their customers 10, or the manager 30 provides to its sellers 20. The system 100 allows each seller 20 to select one or more targeted messages based on a customer loyalty state (e.g., customer status 146, such as active 146a, inactive 146b, or prospective 146c) and/or customer type 144, and/or other customer metrics. Therefore, each customer 10 receives a personalized message or a personalized advertisement campaign (i.e., via mail, email, phone call, etc. . . .) at a personalized time. The seller 20 purchases good/merchandise 31 from a manager 30 (e.g., wholesale or company) and sells the goods/merchandise 31 to the customers 10. In some examples, the seller 20 also provides services in relation to or separate from the goods/merchandise 31 that the seller 20 is selling. The system 100 allows the seller 20 and/or the manager 30 to control marketing strategies, such as the personalized messages and targeted marketing campaigns, and adjust the marketing strategies based on the observations of the customer behaviors.

The customer 10 may be an individual purchaser, a specialty shop, or a resale shop. As shown in FIG. 2B, the seller 20 sets up a marketing campaign 260 that may include one or more of the following: a direct mail marketing campaign 270a; an email marketing campaign 270b; a phone call marketing campaign 270c; a flyer marketing campaign 270d; and a survey marketing campaign 270e for goods 31 purchased by the customer 10 and/or services performed by the sellers 20 or to future purchases and/or future services. The system 100 sends the marketing campaign 260 to one or more customers 10 selected based on specific segmentation criteria 142, and in some examples, the system 100 retrieves customer responses/feedback 12. Once the system 100 retrieves the responses/feedback 12 from the customers 10, the system 100 organizes and analyzes the retrieved responses/feedback 12, and reports the information to a user (e.g., the manager 30 and/or the one or more sellers 20) based on a specific report type 154 (FIG. 2A). The system 100 provides several features and functions that include, but are not limited to: allowing the seller 20 to enter information (via a seller display 206) retrieved from customers 10; a master datastore 120 that includes information (e.g., seller data 220) retrieved from one or more sellers 20 pertaining to customers 10; capability of customer segmentation and filtering based on specific segmentation criteria 142, reporting and tracking of sales and services; identifying specific customers 10 (based on specific segmentation criteria 142) and sending the identified customers 10 targeted marketing campaigns 260; providing the seller 20 (or the manager 30) with template marketing campaigns 262 to create targeted marketing campaigns 260 to specific customers 10; and the capability of viewing sales growth associated with the marketing campaigns 260. In some examples, the system 100 continuously processes data received from the seller 20 and the manager 30, providing information accurate as of the moment a user 20, 30 retrieves the information. In some examples, the system 100 processes the received data on a daily, weekly, monthly, or a customizable or preset period of time. The seller 20 and the manager 30 may use the system 100. The manager 30 creates template marketing campaigns 262, while the seller 20 (or sometimes the manager 30) customizes the template marketing campaigns 262 to generate personalized and targeted marketing campaigns 260 and specifies which customers 10, based on specific segmentation criteria 142 selected by the seller 20 or manager 30, receive the targeted marketing campaigns 260.

The system 100 may be used to facilitate marketing campaigns 260 (specifically targeted marketing campaigns 260) and provide a quantitative understanding of marketing campaigns 260 and sales and/or services associated with the marketing campaigns 260. In some examples, the manager 30 provides the seller(s) 20 more than one brand 32 of a specific product 34. For example, if the manager 30 is a vehicle company, the manager 30 may provide the seller 20 with multiple vehicle brands 32 associated with the company (e.g., Brand A, Brands B. . . . etc.). In such cases, the template marketing campaigns 262 may depend on the specific brand 32, and thus the specific report types 154 may also depend on the specific brand 32. In some examples, the managers 30 provide the sellers 20 with a product 34 (e.g., a vehicle), a part 36 of the product 34 (e.g., product replacement part, such as engine, windshield wipers, or any other parts relating to the vehicle), and accessories 38 (e.g., a bike rack vehicle attachment, or any other vehicle part that is not essential for the vehicle to function). As used herein, a good 31, 34, 36, 38 refers to any one or all of the items sold by the manager 30 to the seller 20, such as products 34, parts 36, and accessories 38. The marketing campaign 260 may relate to one or more goods 31 or services associated with one or more good 31.

The system 100 retrieves transactional information 210 (including sales information 212 and service information 214) from one or more sellers 20 and analyzes transactional information 210 based on each one of its individual sellers 20, or a combination of multiple sellers 20. Moreover, the system 100 may analyze the sales 212 and services 214 based on specific goods 31, brands 32, products 34, parts 36, or accessories 38, or a combination thereof, sold or based on a specific service 214 rendered by the seller 20 to the customer 10. For example, if a manager 30 (e.g., company) sells automotive parts 36 to a seller 20 (e.g., car dealership having a car service division) who in turn sells the automotive parts to customers 10, and in some cases services the vehicle to install and/or repair the part, the system 100 facilitates tracking and analyzing the transactions made between the seller 30 and the customer 10. Therefore, the system 100 can track which of its sellers 20 is selling the most products 34, parts 36, and accessories 38 and to whom (i.e., individual seller or specialty store) and which good 31 among all the sellers 20 is being purchased the most or the least. Thus, based on that tracking, the system 100 allows the seller 20 or manager 30 to personalize the marketing campaigns 260. Although most of the description relates to an automotive wholesale manager 30, an automotive seller 20, such as an automotive dealer selling products 34 (e.g., vehicles), parts 36 (e.g., automotive parts), and accessories 38 (e.g., automotive accessories) based on different brands 32, and a customer 10 buying the automotive parts (as an individual or for resale), the system 100 may be applied to any customers 10 buying from a seller 20, who is in turn buying from a manager 30 or being managed by a wholesaler 30. Therefore, the system 100 may be applied to any goods or services sold having a middle man (i.e., the seller 20) that may setup marketing campaigns 260 and in some examples solicit customers 10 to send responses/feedback 12 that are used by the system 100 for analysis.

In some implementations, a seller 20 or a manager 30 utilizes the transactional information 210 retrieved from multiple customers 10 to determine the customers 10 that the system 100 should send a specific marketing campaign 260. For example, if a customer 10 buys a windshield wipers from a seller 20, then the seller 20 may target that customer 10 and send him/her a marketing campaign 260 relating to windshield wipers after six months from the first purchase, since the seller 20 knows that six months is the timeframe that a customer 10 changes windshield wipers. Therefore, the seller 30 monitors the transactions 210 between the seller 20 and the customers 10 and creates, using marketing templates 262 provided by the manager 30, targeted marketing campaigns 260 to targeted customers 10. As described, the seller 20 sends the personalized marketing campaign 260 to the customer(s) 10; however, the manager 30 may also send targeted marketing campaign(s) 260 to the customer(s) 10. In some examples, the seller 20 is capable of sending marketing campaigns 260 only to customers 10 of the seller 20; while the manager 30 may send a marketing campaign 260 to customers 10 associated with more than one seller 20, thus covering more customers 10.

The system 100 includes one or more data processing devices 110 (e.g., computing device) having a non-transitory memory 112. The one or more data processing devices 110 execute a system software application 114 configured to receive the seller report(s) 220 and provide a report 152 to a user 20, 30. A software application 114 (i.e., a software resource) may refer to computer software that causes a computing device to perform a task. In some examples, a software application is referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The system 100 includes a datastore 120 (e.g., non-transitory memory) in communication with the one or more sellers 20 via a network 15. The datastore 120 stores transaction information 210 received from multiple sellers 20. Non-transitory memory 112, 120 may be physical devices used to store programs (e.g., sequences of instructions) or data (e.g., program state information) on a temporary or permanent basis for use by a computing device 110. The non-transitory memory 112, 120 may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The network 15 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The network 15 may include one or more of a Wide Area Network (WAN), a Local Area Network (LAN), and a Personal Area Network (PAN). In some examples, the network 15 includes a combination of data networks, telecommunication networks, and a combination of data and telecommunication networks. In some examples, the network 15 provides access to cloud computing resources, which may be elastic/on-demand computing and/or storage resources available over the network 15. The term ‘cloud’ services generally refers to a service performed not locally on a user's device, but rather delivered from one or more remote devices accessible via one or more networks 15.

Referring to FIG. 2A, in some implementations, the system 100 includes a segmenter 140 in communication with the datastore 120. The segmenter 140 receives segmentation criteria 142 and segments the stored seller(s) data 220 in the datastore 120 based on the segmentation criteria 142 resulting in customer segmentation 141. The segmentation criteria 142 may include a customer status 146 defined as an active customer 146a, an inactive customer 146b, or a prospective customer 146c. An active customer 146a has an active associated purchase history within a first threshold period of time, for example, within the last 90 days. In some examples, the first threshold period of time is increased or decreased based on the seller 20 or manager 30 preferences. An inactive customer 146b has an inactive associated purchase history of the first threshold period of time, i.e., the customer 10 has not made any purchases from the seller 20 within the past 90 days. In some examples, an inactive customer 146b has an inactive associated purchase history for the first threshold period of time, but has an active associated purchase history for the second threshold period of time. For example, an inactive customer 146b may be a customer 10 who has not purchased from the seller 20 in the last 90 days (first threshold period of time), but has made purchases in the last 24 months (second threshold period of time). The prospective customer 146c has no associated purchase history with the seller 20. In some examples, the prospective customer 146c has an interactive associated history for a third threshold period of time. For example, the prospective customer 146c has not made any purchases in the last 24 months (third threshold period of time).

When the segmenter 140 assigns an active customer status 146a to a customer 10, the active customer status 146a may be further divided into an active defecting status 146aa or an active declining status 146ab. The active defecting status 146aa is associated with a customer 10 who has no associated purchase history within an active threshold period of time that is shorter than the first threshold period of time. For example, the active threshold period of time may be 60 days, which is less than 90 days, the first threshold period of time. Thus, a customer 10 who has not made any purchases from the seller 20 over 60 days but less than 90 days has an active defecting status 146aa. An active declining status 146ab of a customer 10 is when the customer 10 has a threshold decrease in sales over a third period of time, i.e., when the customer's sales are decreasing over the third period of time. The third period of time may be set to one year, two years, a number of years, or the duration that the customer 10 has been purchasing from the seller 20. In some examples, the customer 10 has a status of active defecting 146aa, active declining 146ab, or both. If the customer 10 has an active defecting status 146aa and an active declining status 146ab, then the customer 10 has not made any purchases within the third threshold period of time, and the customer's sales are decreasing.

In some examples, the segmentation criteria 142 includes a customer type 144 defined as a dealer, body shop, a repair shop, shop specialty, a distance from a dealer/seller 20, and/or a brand. The customer type 144 determines characteristics of the customer 10, as compared to the customer status 146, which determines the actions of a customer 10. The segmenter 140 may determine the customer type 144 of each customer 10 based on the name of the customer 10 stored in the datastore 120, and previously received by the dealer marketing system 200. For example, if the customer name is “Joe's Body Shop,” the segmenter 140 determines that the customer type 144 is a body shop. In another example, where the customer name is “Sal's Auto-Parts,” the segmenter 140 determines that the customer type 144 is an auto part seller. The segmenter 140 may determine the customer type 144 based on specific word matches between a list of words and a name of the customer 10. The list of words may be determined by the manager 30 and the segmenter 140 may associate specific words with the customer type 144. For example, the list of words may include: parts, auto-parts, engines, transmission; if the customer name includes any of these words, the segmenter 140 determines that the customer type 144 is a body shop.

The segmentation criteria 142 may also include transaction information 210 of one or more sellers 20 that includes sales information 212 and service information 214 relating to a brand 32, a product 34, a part 36, and/or an accessory 38. The segmentation criteria 142 may also include any segmentation criteria 142 that groups one or more customers 10 based on one or more common transaction, action, or similarity.

In some implementations, a seller 20 selects a segmentation 141, such as a customer type 144 and/or a status 146 and/or a type of transaction performed with the customer 10, and based on the segmentation 141 the seller 20 may determine which template campaign 262 to use for the targeted marketing campaign 260. A template campaign 262 is a marketing campaign 260 preloaded with one or more default message, design, and includes several variables that may be customized based on the targeted customer 10. For example, the seller 20 may decide to provide a prospective customer 146c with a greater incentive (i.e., a coupon with a greater discount) to visit the seller 20 (or the manager 30) than the seller 20 wants to give an active customer 146a. In some examples, the seller 20 (or the manager 30) selects a segmentation criteria 142 that results in a segmentation 141 of customers 10 who purchased a specific good 31 within the past 5-6 months. The specific good may have a use life of 7-8 months; therefore, the seller 20 (or the manager 30) may send a marketing campaign 260 to the selected segmentation 141 of customers 10 based on the selected segmentation criteria 142. In some examples, the segmentation 141 is specific to customers 10 who made purchases or received a service in relation to a specific good 31, such as a brand 32, a product 34 of any or a certain brand 32, a part 36 of any or a certain brand 32, and/or accessories 38 of any or a certain brand 32.

Referring back to FIGS. 1 and 2B, in some examples, to accumulate the transaction information 210 that allows the segmenter 140 to segment the stored seller(s) data 220 in the datastore 120 based on the segmentation criteria 142 resulting in customer segmentation 141, each seller 20 has a seller management system 200 that allows the seller 20 to collect transaction information 210 and generate the seller data 220 that includes all the received transaction information 210. The seller 20 interacts with multiple individual customers 10 purchasing a good 31 or service from the seller 20. The seller 20 is the seller or provider of a good 31 or service, and the customer 10 purchases the goods 31 or services from the seller 20. The seller data 220 includes a cumulative of all the information collected from each individual customer 10. The seller management system 200 allows the seller 20 to create targeted marketing campaigns 260 using the information collected from customer 10. The seller management system 200 is a system data processor (e.g., computing device) having non-transitory memory 202 and executing a seller software application 204 for retrieving customer information. The seller software application 204 may execute on the seller management system 200 or the one or more data processing devices 110. In addition, the seller software application 204 and the system software application 114 may be one application or separate applications in communication via the network 15. The seller management system 200 includes a customer display 206 for displaying a customer interface 208 that allows the seller 20 to input transaction information 210 of customers 10, and allows the seller 20 to modify/update the marketing campaign templates 262 and create targeted marketing campaign 260 by way of the seller software application 204. The transaction information 210 that may be entered in the seller management system 200 and stored in the non-transitory memory 202 of the seller management system 200 (retrieved by the datastore 120 or sent to the datastore 120) may include a purchaser name, address, phone number, date of service or purchase, good 31, brand 32, product 34, part 36, or accessory 38 purchased, type of service rendered, or any other information. In some examples, the customer display 206 is in communication with the seller management system 200 and displays an interactive report 152 generated by a reporter 150. The display 206 may be a handheld device display 26 or a display wirelessly connected to the seller management system 200. In some examples, certain portions of the report 152 are only available to one or the other of the handheld device display 26 or the wirelessly connected display 116.

The datastore 120 receives seller data 220 from the seller(s) 20. In some examples, the datastore 120 continuously receives the seller data 220, while in other examples, the datastore 120 periodically receives the seller data 220, where periodically may refer to any period of time interval. Therefore, based on the seller data 220, the manager 30 may update the marketing campaign templates 262, and the seller 20 may retrieve the updated marketing campaign templates 262 and send updated marketing campaigns 260 to the customer 10. In some examples, the seller data 220 includes one or more of the following: parts invoice data (that include detail information of goods 31 sold by the seller 20 to the customer 10), parts inventory data (that include merchandise 31 stocked at the seller 20 (e.g., dealer) including, but not limited to, quantity on hand, lost sales, bin location, stocking status, and last sold date), and vehicle data (e.g., vehicle service data, vehicle sales data, and vehicle inventory data). The system 100 may be flexible to accommodate more or less data included in the seller data 220. The seller data 220 may be a pipe delimited flat file, a comma delimited flat file, a comma-separated values (CSV) file, an extensible markup language file (xml), or any other file type capable of being received by the datastore 120.

Referring to FIG. 2A, the system 100 may also include an analyzer 160 and a reporter 150 executing on the one or more data processing devices 110 and in communication with the datastore 120. The analyzer 160 is in communication with the datastore 120. The analyzer 160 analyzes data (e.g., seller records 220) from the datastore 120 to provide a report by way of the reporter 150. The analyzer 160 also analyzes the marketing campaign(s) 260 that the seller 20 sends to the customers 10. In some examples, the analyzer 160 also analyzes the customer responses/feedback 12 received from multiple customers 10 after the customers 10 responded to targeted marketing campaigns 260.

The reporter 150 is in communication with the datastore 120 and the analyzer 160. In some implementations, the reporter 150 generates a report 152 based on the analyzer 160 and the analyzed data (e.g., seller records 220, marketing campaign(s) 260, customer responses/feedback 12). The reports 152 may include a table or graphical illustration illustrating the analyzed data. In some examples, the reporter 150 generates an interactive report 152 for display on an electronic display 26, 116, 206. In some implementations, the seller 20 or the manager 30 views the report 152 on a web browser or a web-based application in communication with the network 15.

In some implementations, the system 100 includes an electronic display 116, 206 in communication with the system data processor 110. The display 26, 116, 206 is configured to display one or more report types 154 based on the modules 310 and the user 20, 30 selects which report type 154 to view. The electronic display 116, 206 may be a handheld device display 26 or a display wirelessly connected to the system data processor 110. In some examples, certain portions of the report are only available to one or the other of the handheld device display 26 or the wirelessly connected display 116.

The reports 152 may be structured based on the analysis context. In some examples, the reports 152 are parts reports 154a or seller loyalty reports 154b. The parts reports 154a include any reports relating to the quantity and/or quality of the sales provided by the seller 20. The loyalty report 154b includes any reports relating to the loyalty of the seller 20 to the manager 30. A user 20, 30 may select a report type 154a, 154b via a display 26, 116, 206 and the reporter 150 displays on the display 26, 116, 206 the selected report type 154a, 154b.

Multiple users may access the system application 114 to view the available reports 154. The user may be a seller 20, a manager 30 (a corporate manger or a field manager), or a specialist. In some examples, the role of a seller 20 is an individual who has interests in the operations of its own specific sales operation (e.g., dealership); therefore, the seller 20 may view and access information pertaining only to its own dealership. The corporate manager may be a non-seller individual belonging to a specific brand organization, and oversees the brand as a nation; therefore, the corporate manager may view information relating to all sellers 20 belonging to the specific brand. The field manager may be a non-seller individual belonging to either a first brand 32 or a second brand 32 and tied to particular region/area of the brand 32; therefore, the corporate manager may view information for all sellers 20 belonging to his or her brand 32 within the region/area. A specialist may have special permissions, typically they are used for special programs (e.g. wholesale specialist) and the access is restricted to specific information; therefore, this role may be defined per request.

In some implementations, different users 20, 30 are granted different levels of reports access. The system 100 identifies the user 20, 30 and based on the user identification, the system 100 determines the reports that are available to the user 20, 30.

In some examples, the system 100 uses SAML (Security Assertion Markup Language) SSO (Single Sign On). SAML is an WL-based open standard data format for exchanging authentication and authentication data between parties, in particular, between an identity provider and a service provider. SSO is a property of access control of multiple related but independent software systems, which allows a user to log in to a system 100 once and the user gains access to all the systems without having to log in at each of the independent software systems.

In other examples, the system 100 uses direct secured login, which provides an access point for users 20, 30. The user name and passwords are stored within the application and maintain no outside dependencies. This access will be granted selectively with approval from the project business owner. The system 100 may use other methods for securely authenticating the user 20, 30.

Referring back to FIG. 2B, the targeted marketing campaign 260 includes one or more marketing campaign types 270, such as but not limited to, direct mail marketing campaign 270a, email marketing campaign 270b, phone call marketing campaign 270c, flyer marketing campaign 270d, and survey marketing campaign 270e. A manager 30 sets up marketing campaign templates 262 for each marketing campaign type 270. Then the seller 20 or the manager 30 uses a marketing campaign template 262 to create a marketing campaign 260 for a specific group of customers 10 or a segmentation 141 of customers 10 based on specific segmentation criteria 142.

In some implementations, the campaign marketing templates 262 are specific to a year of a manufacture of a brand 32, product 34, part 36, or accessory 38. For example, the campaign marketing template 262 may be specific to brand A, and one or more of a product 34, part 36, or accessory 38 related to brand A. The campaign marketing templates 262 may be specific to a certain month. For example, the campaign marketing template 262 may be specific to the month of July in celebration of 4^{th} of July. The campaign marketing template 262 for July may include drawing and art indicative of the 4^{th} of July celebration. Moreover, the campaign marketing templates 262 may be specific to a customer type 144 and/or a customer status 146 and/or other specific segmentation criteria 144. For example, the marketing campaign template 262 may include different coupons for customers having an active status 146a, inactive status 146b, or a prospective status 146c. The marketing campaign templates 262 may also depend on the customer 10, i.e., if the client is a parts dealer, a body shop, a repair shop, shop specialty. For example, the marketing template 262 designed for a parts seller may be specific to parts that the parts seller buys from the seller 20, which may be different than the parts that a repair shop may buy from the seller 20. In some examples, the manager 30 provides different sellers 20 with different marketing campaign templates 262, based on the goods 31 and services that the seller 20 offers and/or the customers 10 of the seller 20.

In some implementations, each marketing campaign template 262 has one or more variables that the manager 30 can customize to any set of marketing messages and designs. For example, the manager 30 may select a different font for different marketing campaigns template 262, or select different fonts within the marketing campaign template 262. The manager 30 may select images from a group of available images to include in the marketing campaign template 262. The manager 30 may also select specific colors of the font, the images, or the background of the marketing campaign template 262. As described, the manager 30 may create or update a marketing campaign template 262 for any one or more of a marketing campaign type 270 (direct mail 270a, email 270b, flyer 270d, and surveys 270e). Since a phone call marketing campaign 270c is limited to specific text or script that a caller reads to the customer 10, the manager 30 is limited to determining the script that the caller should read to the customer 10 over the phone. The templates 262 may include a discount or a coupon that allows the customer 10 to purchase goods 31, 34, 36, 38 or services from the seller 20 at a special or reduced price. In some examples, the templates 262 include reminders of upcoming scheduled service.

Once the manager 30 has completed creating or adjusting the marketing templates 262, the system 100 stores the templates 262 in its datastore 120 allowing the seller 20 access to the templates 262 to create his/her targeted marketing campaign 260 based on the template(s) 262 provided by the manager 30. The seller 20 or the manager 30 may retrieve a template marketing campaign 262 and modify or update it so that the seller 20 or manager 30 sends a personalized marketing campaign 260 based on the marketing campaign type 270 (e.g., direct mail 270a, email 270b, phone call 270c, flyer 270d, surveys 270e).

In some examples, every threshold period of time (e.g., monthly, bi-weekly, weekly or daily), the seller 20 retrieves the templates 262 from the datastore 120 and customizes the marketing campaign templates 262 resulting in targeted marketing campaigns 260. The system 100 provides the seller 20 with a library 264 of templates 262 and messages 266 and coupons 268 that the manager 30 created. For example, a seller 20 decides to send out a targeted marketing campaign 260 to a select group of customer 10, e.g., based on a specific segmentation 141 (for example, based on customer type 144 and/or customer status 146 and/or goods 31 purchased or services rendered, or other segmentation criteria 144). The seller 20 selects a template 262 of one of a direct mail 270a, an email 270b, a phone call 270c, a flyer 270d, or a surveys 270e from the template library 264 stored on the datastore 120, then selects predetermined messages 266 and/or coupons 268 associated with the selected template 262. Once the seller 20 completes his/her selection of a template 262, messages 266 and/or coupons 268, the resultant modified template 262 is the targeted template 260 that the system sends to the one or more customer(s) 10. In some examples, the seller 20 modifies or includes specific messages 266 or coupons 268 updating the messages 266 and coupons 268 retrieved from the datastore 120. The predetermined messages 266 may include text specific to the seller 20. For example, “Come Celebrate our 20^{th} Anniversary!!” or “Come Check out the Big Sale at Bob's Auto-Shop!” The coupons 268 may include text specific to the coupon 268, such as, “20% off everything!!” or “buy the part and we'll give you 10% off!”

In some implementations, the system 100 sends a targeted marketing campaign 260 to one or more customer(s) 10 without a seller's (or manager's) interference or modifications of the templates 262. For example, if within a predetermined amount of time a seller 20 has not retrieved a template 262 from the datastore 120, the system 100 (i.e., seller management system 200) may automatically customize one or more marketing campaigns 260 for the customers 10. In some examples, the marketing campaigns 260 are for a specific segmentation 141 of customers 10 for each seller 20 or for all the sellers 20. In some implementations, the system 100 is in communication with a printer(s) (not shown). Each printer may be in communication with a seller management system 200 of a seller 20. In some examples, the system 100 sends direct mail 270a and/or a flyer 270d marketing campaign 260 to a printer associated with a seller 20. While in other examples, the printer is associated with a printing company who prints and sends out the advertising mail 270b or flyers 270d. The printer prints a specified number of copies of direct mail 270a and/or flyers 270d that are sent to the customers 10. In some examples, the direct mail 270a and/or a flyer 270d includes a name and address of each customer 10 allowing the seller 20 to only mail the direct mail 270a and/or a flyer 270d to the customer 10. In some examples, the printer includes specific settings for printing the direct mail 270a and/or a flyer 270d, for example printing on both sides of a paper or card, the size of the paper or card, the number of copies to make, whether to include the name and address of the customer, and other settings.

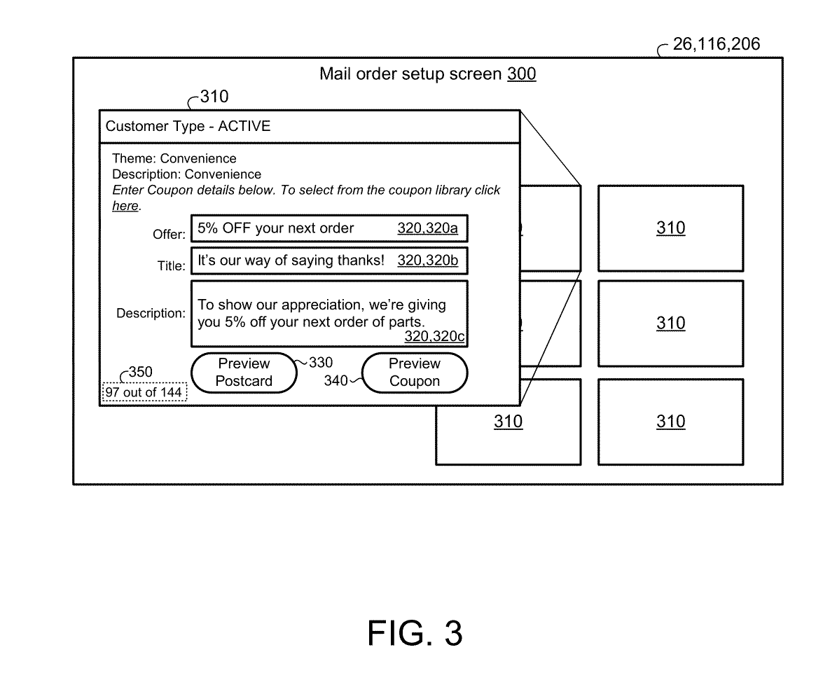

Table 1 below provides an example setting of a direct mail marketing campaign 270a that generates automated advertisement mail. FIG. 3 shows a display 26, 116, 206 displaying a direct mail marketing campaign 270a setup screen that customizes a seller's offer to individual customers 10, i.e., a segmentation 141 of customers 10.

TABLE 1

| | |
|---|---|
| Description | Mailing of postcards by an automated system on |
| | behalf of the dealers |
| Frequency | Monthly (or other specified period of time) |
| Process | 1) The manager selects three benefits or one coupon |
| | for the customer. This is default setup. |
| | 2) The seller uses the Mailer order setup screen |
| | (FIG. 3) to customize their offers to individual |
| | customer segments based on a segmentation. The |
| | seller can either keep a default offer or customize |
| | the offer to their individual business needs. The |
| | direct mail has a radius limit having a seller |
| | location as the center of the radius. |
| | 3) To setup a given month, a seller has until a |
| | preset date of a previous month (e.g., the 15^{th} of |
| | the previous month) to make any changes to the |
| | template advertisement campaign. At the same time, |
| | sellers can plan and create offers months in |
| | advance. |
| | 4) A data file of the mail or postcard contents is |
| | created and may be outsourced to a printing company |
| | who mails the mail or postcard to the customers on |
| | behalf of the sellers. The postcards are expected |
| | to arrive by the beginning of the month. |

As shown in FIG. 3, the order setup screen 300 includes one more template mail advertisement campaigns 262, 310. A seller 20 may select a template mail advertisement campaign 262, 310 and update the template mail advertisement campaign 262, 310 resulting in a personalized mail advertisement 270a. As shown, the template mail advertisement campaign 262, 310 includes multiple fields 320 that the user 20, 30 may update. For example, the template mail advertisement campaign 262, 310 may include an offer field 320 a that allows the user 20, 30 to edit the offer on the personalized mail advertisement 270a. In some examples, and as previously described, the datastore 120 includes a library 264 that includes messages 266 and coupons 268 that the seller 20 may use to update the fields 350. Another field 350 may be a title field 320b, where the seller 20 (or manager 30) may update the title of the template mail advertisement campaign 262, 310 to personalize it. Yet another field 350 may be a description field 320c that includes description or more details relating to the offer. The seller 20 (or manager 30) may update the description of the template mail advertisement campaign 262, 310 to personalize it. The seller 20 (or the manager 30) may select a preview postcard button 330 or a preview coupon button 340 to preview the updated fields 350. If the user 20, 30 selects the preview postcard button 330, the personalized mail advertisement 270a will be shown as a postcard; while if the user 20, 30 selects the preview coupon button 330, the personalized mail advertisement 270a will be shown as a coupon. In some examples, an indicator 350 of the template mail advertisement campaign 262, 310 indicates a number of the template mail advertisement campaign 262, 310 out of the total number of available template mail advertisement campaign 262, 310. For example, and as shown in FIG. 3, the indicator 350 indicated that the template mail advertisement campaign 262, 310 is the 97^{th} template out of a total of 144 template mail advertisement campaigns 262, 310.

In another example, the system 100 automatically generates an email 270b marketing campaign 260 and sends the emails 270b to the customers 10. The system 100 may create and send the emails 270b at the end of the month if the seller 20 has not created any marketing campaigns 260 during the month. Other time frames are possible as well. The system 100 sends the emails 270b to a customer's primary email address entered into the seller system 200 by the seller 20 and provided by the customer 10. In some examples, the system 100 fails to send an email to the customer's primary email address due to an invalid email address or a missing email address. In this instance, the system 100 sends the email 270b to the customer's secondary email address, which may also be entered into the system 100 by the seller 200 at the seller system 200 via the seller application 204. The system 100 may embed tracking as a feature in the marketing email 270b. The email tracking may be accomplished using cookies and web beacons. Web beacons are objects embedded in a web page or email and are usually invisible. Web beacons allow monitoring of user activity, specifically when or if a user has accessed the content of a web page of an email. Relating to emails, marketers (i.e., sellers 20 and managers 30) can determine which customers 10 opened the marketing email 270b, and based on that determine the next step of whether to engage the customer 10 once more or wait some time before re-engaging the client. The system 100 may track various email marketing campaign metrics, such as, but not limited to, an open rate of the emails 270b, blocked emails, click-through rates of the emails 270b, etc. A click-through rate can be a ratio of clicks to impressions of an online advertisement or an email marketing campaign 270b. The higher the click-through rate, the more effective the marketing campaign was at bringing people, such as customers 10, to the website. Thus, the click-through rate is the number of times a click is made on the advertisement divided by the total impressions or the number of times an advertisement was served. More specifically, an email click-through rate is the number of customers 10 receiving the email who click one or more links in the email 270b and land on the sender's (i.e., the manager's) website, blog, or other desired destination. In some examples, a seller 20 or a manager 30 checks the automatically generated advertisement email 270b before the system 100 automatically sends the email to the customer segmentation 141. The seller or the manager 30 may also determine/change/update the customer segmentation 141 selected by the system 100. In some examples, each advertisement email 270b includes an unsubscribe link that once the customer 10 selects the link, the customer 10 is capable of removing themselves from the mailing list and will no longer receive advertisement emails 270b from the seller 20 and/or manager 30.

In some implementations, each email template 262 has one or more variables that the seller 20 or the manager 30 can customize to any set of marketing messages and designs. For example, the seller 20 or the manager 30 may select a different font to be used in the email 270b, adjusting the template email 262 to personalize it. The seller 20 or the manager 30 may select images from a group of available images to include in the email 270b. The seller 20 or the manager 30 may also modify the colors of the font, the images, or the background of the email template 260 to send to its customers 10 as a personalized advertisement email 270b.

Table 2 below provides an example setting of an automated advertisement email 270b.

TABLE 2

| | |
|---|---|
| Description | Automated e-mails to customers on behalf of the |
| | Sellers |
| Frequency | Monthly (or other specified period of time) |
| Process | 1) The manager chooses between three benefits or |
| | one coupon for the customer. This is default setup, |
| | i.e., template setup. |
| | 2) The dealer uses the Mailer order setup screen |
| | 310 (FIG. 3) to customize their offers to |
| | individual customer segments based on a |
| | segmentation. The dealer can either keep a default |
| | offer or customize the offer to their individual |
| | business needs |
| | 3) To setup a given month, a dealer has until a |
| | preset date of a previous month (e.g., the 15^{th} of |
| | the previous month) to make any changes. At the |
| | same time, dealers can plan and create offers |
| | months in advance. |
| | 4) The email is delivered on a predetermined date |
| | (e.g., the second Thursday of the marketing month) |
| | on behalf of the dealers. |

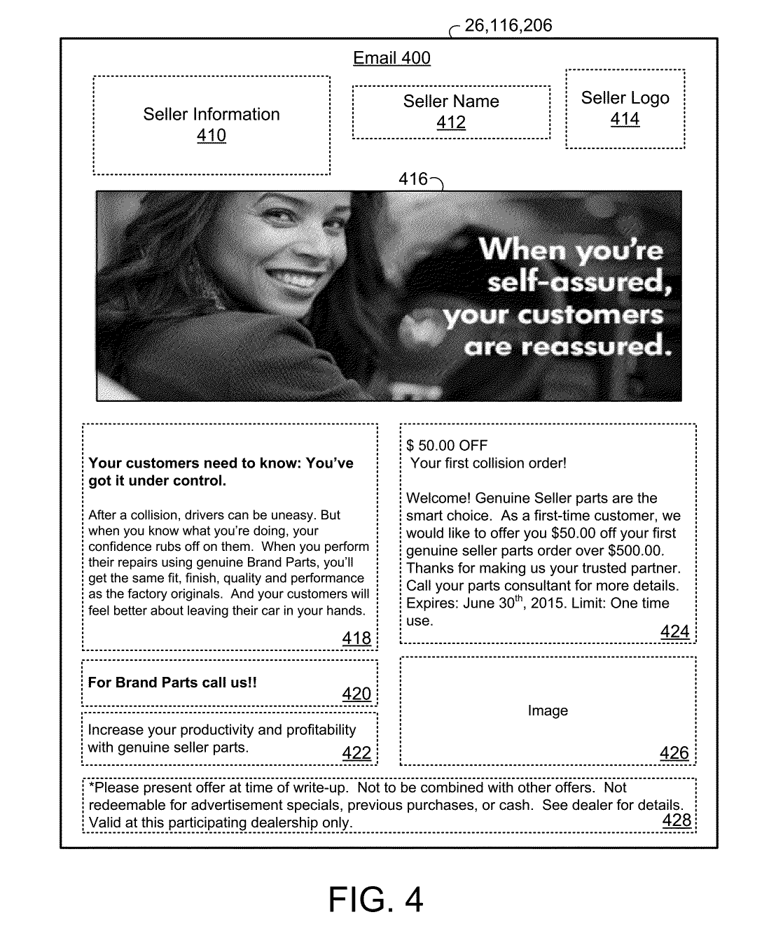

FIG. 4 shows an exemplary personalized advertisement email 270b, 400. As shown, the personalized advertisement email 270b, 400 contains sections 410-428, each section being a place holder for specific information. For example, a seller information section 410 may include the seller's address, hours of operation, phone number, email, and any relevant information. A seller name section 412 may include the seller name. A logo section 414 may include a seller logo. First and second image sections 416, 426 may include images. Text sections 418, 420, 422, 424, 428 may include information pertaining to the seller 20 or the specific offer or general information. In some examples, the seller 20 repositions the sections 410-428 within the personalized advertisement email 270b, 400 or decides to remove some sections 410-428 or change the text of some of the sections 410-428.

In other examples, the system 100 automatically generates a phone call marketing campaign 270c that includes a phone call template script/text. The phone call marketing campaign 270c is then sent to a call center system, which creates call queue(s) for live agents to execute outbound sales calls to customers 10 on behalf of the seller 20. In some examples, the phone call marketing campaign 270c includes a list of the customers 10 generated by the system 100 and an overview of their transactions with the seller 20. Additionally, the phone call marketing campaign 270c may be based on a specific customer segmentation 141. The live agents call the customers 10 using the template script/text that includes a seller's information. For example, the phone call template script/text may be personalized based on the customer 10 associated with the seller. Therefore, if customer John is a client of seller Dealer Bob, then the phone call template script/text will include Dealer's Bob's information. An example of a phone call template script/text may be: “Hello John! This is Chris from Dealer Bob's. How are you today? Our records indicate that you are due for an oil change, would you like to schedule one today?” Additionally, the phone call template script/text may be personalized based on specific offers or discounts that a specific seller 20 is offering. In some examples, the seller 20 reviews and confirms the customers 10 that the system 100 selected for the call center to call. Additionally, the seller 20 may update, add, or remove customers 10 from the list of customers 10 generated by the system 100 that the call center may add to the call queue. During the call, the customer 10 may decide to order a good(s) 31 or schedule a service with the seller 20. In such a case, the call center may transfer the call to the seller 20 so that the seller 20 can take over the call and either place the order for the good(s) 31 or schedule the service.

The system 100 may generate the list of customers 10 to include customers 10 that are not on a “do not contact list” and have a valid phone number on file. In some examples, when the customer 10 is a specialty store, priority calls are made to import shops and shops with the highest sales by volume. The system 100 does not include shops that are not interested in phone marketing campaigns 270c or do not wish to be contacted via phone. Other requirements may also be available to determine the generated list of customers 10 to be contacted by phone.

The call center may provide a call report back to the seller 20 and/or the manager 30 relating to completed and uncompleted calls, which include follow-up calls when needed, hang ups, wrong numbers, messages left, not interested, buying parts elsewhere, no response, out of business, or busy.

The system 100 tracks the direct mails 270a, the emails 270b, and the phone calls 270c made to customers and generates key performance indicators (KPI) to measure the effectiveness of these marketing campaigns 260. A KPI is a performance measurement that evaluates the success of an organization or of a particular activity in which it engages, in this case advertising using direct mails 270a, the emails 270b, and the phone calls 270c, and any other advertising methods.

Table 3 below provides an example setting of an automated phone marketing campaign 270c.

TABLE 3

| | |
|---|---|
| Description | A third party call center “cold call” customers on |
| | behalf of dealers |
| Frequency | Monthly (or other specified period of time) |
| Process | 1) The system provides/identifies a list of |
| | customers to “cold call” on behalf of the dealers |
| | based on number of variables, such as sales |
| | history, loyalty segment, shop specialty, distance |
| | from dealers, growth in sales, etc. |
| | 2) Dealers select the list of customers to call and |
| | have the option of customizing the call script |
| | offer. |
| | 3) Manager/seller processes the customer data file |
| | e.g., on the 26^{th} of the month. The file is |
| | available the next day, which is sent to the call |
| | center that provides the service on behalf of the |
| | dealers on the first weekday of the following month |
| | or other predetermined time. |
| | 4) Upon completion of all the calls, the call |
| | center sends a file containing feedback of customer |
| | responses to the manager/sellers. |
| | 5) The feedback is loaded back into the system and |
| | displayed on the portal for dealers to view on a |
| | “Live Agent Call Responses” page. |

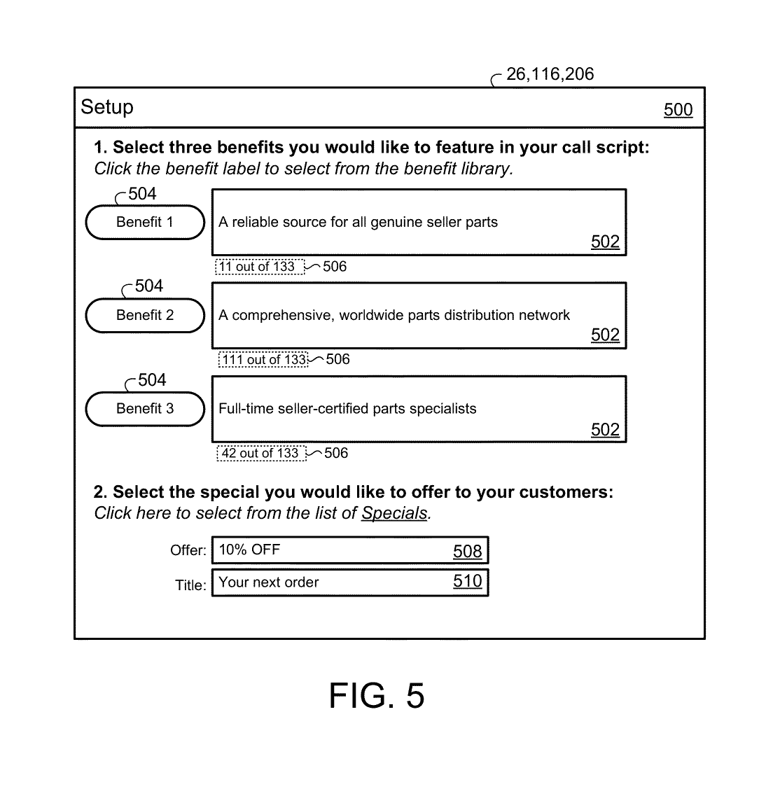

FIG. 5 shows an exemplary phone call setup page 500 displayed on a display 26, 116, 206. The system 100 prompts the user 20, 30 to select at least one benefit that the user 20, 30 wants to feature in the phone call script. As shown, the user 20, 30 may select three benefits 502. In some examples, the user 20, 30 selects a benefit button 504 that provides the user 20, 30 with a list of benefits to choose from. When the user 20, 30 selects a benefit 502 by way of the benefit button 504, each benefit is associated with a benefit number 506, which may be displayed near the benefit. As shown, Benefit 1 is associated with a benefit number 506 “11 out of 133”, 133 being the total number of benefits stored in the system's non-transitory memory. In other examples, the user 20, 30 may enter benefits that are not a selection from the benefit list. The user 20, 30 may also add an offer value in an offer value text box 508 and a title to the phone call script in a phone script title text box 510. In some examples, the offer value text box 508 when selected, takes the user 20, 30 to the coupon library 264 allowing the user 20, 30 to select a coupon from the library 264. In some examples, the phone call setup page 500 includes a text box (not shown) to enter the seller information. Additionally, the phone call setup page 500 may include a preview button (not shown) allowing the user 20, 30 to preview the final phone call script.

In some examples, the system 100 generates flyer templates 262 that the seller 20 or the manager 30 may use as a template and may customize and print at the seller location using the system application 114. The seller 20 (or the manager 30) may interact with the system 100 via a display 26, 116, 206. Each flyer template 262 may have one or more variables that the seller 20 or the manager 30 can customize to any set of marketing messages and designs. For example, the seller 20 or the manager 30 may select a different font to be used in the flyer 270d adjusting the template flyer 262. The seller 20 or the manager 30 may select images from a group of available images to include in the email 270b. The seller 20 or the manager 30 may also modify the colors of the font, the images, or the background of the flyer template 260 to send to its customers 10 as a flyer marketing campaign 270d.

Table 4 below provides an example setting of a flyer advertisement 270d.

TABLE 4

| | |
|---|---|
| Description | The dealers create flyers based on the template |
| | provided by the manager |
| Frequency | On Demand |
| Process | 1) The manager creates the template for the flyer |
| | 2) The dealer selects a flyer from a set of |
| | standard templates under “Marketing And Custom |
| | Wholesale Parts Flyer.” They also have the option |
| | to include a custom message |
| | 3) The dealer prints the flyer on an 8½ × 11 |
| | paper and passes it to the customers |

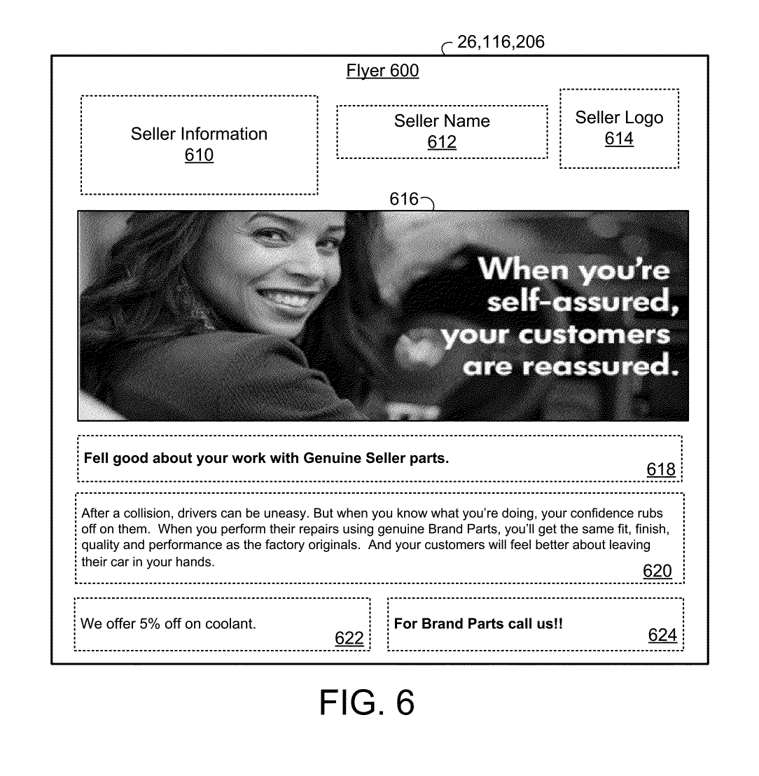

FIG. 6 shows an exemplary personalized flyer 270d. As shown, the personalized flyer 270d, 600 contains sections 610-624, each section being a place holder for specific information. For example, a seller information section 610 may include the seller's address, hours of operation, phone number, email, and any relevant information. A seller name section 612 may include the seller name. A logo section 614 may include a seller logo. An image section 616 may include images, the user 20, 30 may add more than one image by adding more image sections 616. Text sections 618-624 may include information pertaining to the seller 20 or the specific offer or general information. In some examples, the seller 20 repositions the sections 610-624 within the personalized flyer marketing campaign 270d, 600 or may decide to remove some sections 610-624 or change the text of some of the sections 610-624.

The system 100 may generate survey marketing templates 262 based on questions and comments of the manager 30. The surveys 270e allow the seller 20 and the manager 30 to determine the customer satisfaction, and based on the survey feedbacks 12, the seller 20 and/or manager 30 find ways to improve their process to better service the customers 10.

In some examples, the surveys 270e are delivered to a customer 10 via their email. The surveys 270e may be sent to customers who have one or more of valid email, have a sale the day before the survey 270e will be sent (i.e., sale >$ 0), have not responded to a survey within a threshold number of days (e.g., 60 days), have not received a survey 270e within a threshold number of days (e.g., 15 days), and are not on a no contact list. Other customer requirements may also be available to determine the customers 10 that the surveys will be sent to.

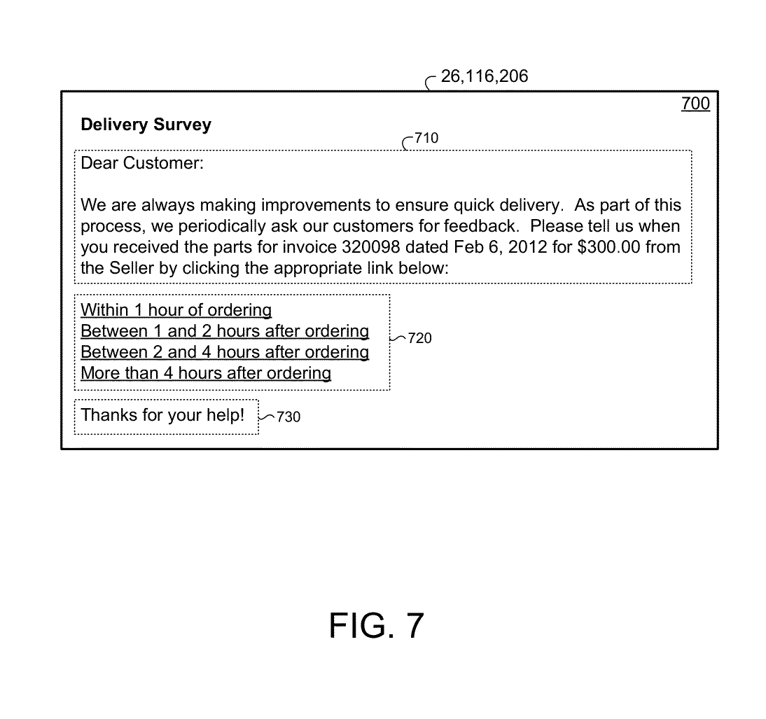

The surveys 270e may reference specific invoices and specific transaction information 210 of a customer 10 with a specific seller 20. In some examples, the surveys 270e are geared to determine how fast a good 31 was delivered to a customer 10. For example, one of the questions/texts on the survey 270e may be: I received parts within 1 hour of my ordering, between 1 and 2 hours, between 2 and 4 hours, more than 4 hours; or I received parts within 24 hours of my ordering, within 48 hours of my ordering, between 2-4 days of my ordering, more than 4 days of my ordering, depending on the type of goods 31, where the customer 10 selects one of the options. Additionally, the survey 270e may include a check box or any other type of indicator that allows the customer 10 to indicate if they want to be contacted again or not. Some surveys 270e may include a comment box allowing the customers 10 to enter comments. FIG. 7 shows an exemplary personalized advertisement flyer 270d, 700 that includes sections 710, 720, 730. In a first section 710, the flyer 270e, 700 includes the personalized text. In a second section 720, the flyer 270e, 700 may include options that the customer 10 can select to respond to the first section 710. As shown, only one question/response is displayed; however, the survey 270e, 700 may include multiple questions/answers. Additional sections 730 may also be included to allow the user 20, 30 to input additional text.

In some examples, the surveys 270e are geared to determine customer satisfaction with the seller 20. This seller satisfaction survey 270e may be sent to customers 10 a threshold number of times each year, e.g., one or twice each year. For statistical significance, the manager 30 or seller 20 may send about 15 surveys per quarter per seller 20. The seller satisfaction surveys 270e may include a combination of email and phone surveys. The seller 20 may use the template survey 262 or may update the template survey 262 by adding, removing, modifying questions /comments of the template survey 262.

The seller satisfaction surveys 270e may be sent to customers 10 who satisfy one or more of the following: have a valid email address; have customer status 146 of active 146a, inactive 146b, or prospective 146c; have not previously responded to a customer satisfaction survey 270e; and are not on a do not contact list. In one example, the seller satisfaction survey includes a Collision Parts Satisfaction Survey that includes 10 questions covering satisfaction with parts ordering, delivery, marketing, overall service from the dealership; and a Mechanical Parts Satisfaction Survey that includes 10 o questions covering satisfaction with parts ordering, delivery, marketing, overall service from the dealership. The seller satisfaction surveys 270e may be sent a number of times based on a response rate of the customer(s) 10 and whether the customer 10 has and email/phone number on record.

For each survey type, the system 100 calculates various metrics including, but not limited to: Top box and top two box scores calculated for each question per dealer; Shop detail report; and Seller, Regional and Corporate summary report. The reports may be made available to sellers 20 and managers 30.

Table 5 below provides an example setting of a delivery survey 270e.

TABLE 5
Delivery Surveys

| | |
|---|---|
| Description | An automated process where customers are asked to |
| | provide a feedback of their experience of ordering |
| | parts with the dealer |
| Frequency | 3 days a week - Wednesday, Thursday and Friday (or |
| | other specified period of time) |
| Process | 1) The manager/seller selects customers from |
| | previous day invoices. |
| | 2) Customers with valid Emails are sent an email |
| | survey. |
| | 3) Customers click on any one of the four links |
| | indicating his experience of the time the dealer |
| | took to deliver. |
| | 4) The customer feedback, including any optional |
| | comments, is recorded in the datastore. |
| | 5) The results of the feedback are displayed in the |
| | portal or the application 204, 114 under |
| | Customers > Delivery Survey Results. |

Table 6 below provides an example setting of an satisfaction survey 270e.

TABLE 6
SATISFACTION SURVEYS

| | |
|---|---|
| Description | A third party call center or online survey conducts |
| | the survey on customer experience with dealers. |
| Frequency | Quarterly |
| Process | 1) The manager generates a list of customers based |
| | on whether the customer has a phone number or a |
| | valid email. |
| | 2) Dealer may set up one custom question along with |
| | the standard questions. |
| | 3) Data files containing customers to be contacted, |
| | along with the script of questions are sent to a |
| | third party call center to obtain customer feedback |
| | on their experience with dealers. |
| | 4) The results of the survey are sent back to the |
| | manager to be uploaded onto the system and |
| | displayed on the portal. |

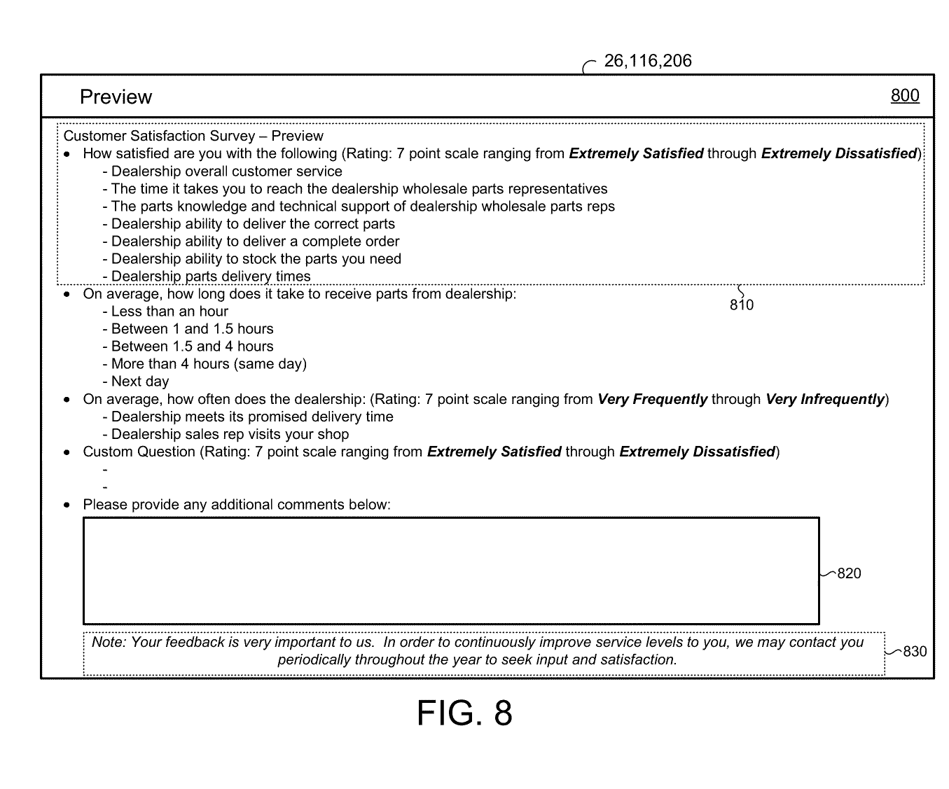

FIG. 8 shows an exemplary setup screen 800 for personalizing a survey 270e from a survey template 260. As shown, the setup screen 800 includes sections 810-830. A first section 810 includes a question and multiple answers that the customer 10 may later select. As shown, the template survey 270e includes four questions where the fourth question may be added by the seller 20. In some examples, the template 260 includes a text box 820 allowing a customer 10 to enter additional information/comments. The template survey 260 may include one or more text boxes 830 with text/comments from the seller 20 or manager 30. The text boxes 830 may be updated to personalize the survey 270e.

Table 7 below provides an example setting of a generic template marketing campaign 260.

TABLE 7
Marketing Template Management

| | |
|---|---|
| Description | Backend function, which allows the manager to |
| | establish standard set of templates with several |
| | variation possibilities. These templates are then |
| | available to dealers to customer for their |
| | messaging. |
| Frequency | On Demand |
| Process | 1) Seller/manager provides a set of requirements to |
| | the manager to create a set of standard templates |

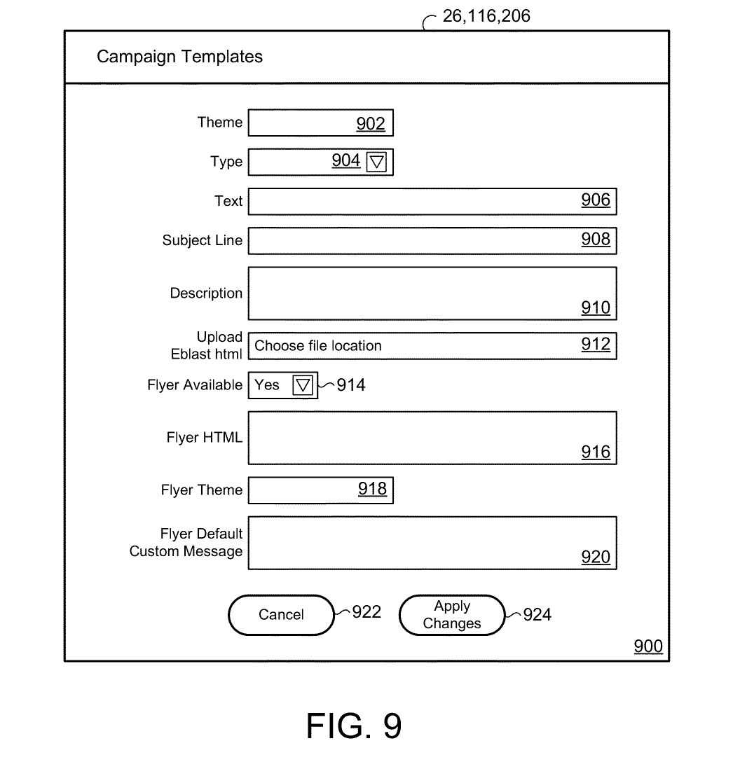

FIG. 9 shows an exemplary screen 900 for selecting an advertisement campaign template 260 to personalize. In a theme box 902 the manager 30 creating the template 260 may enter text describing the theme of the advertisement campaign template 260. A type drop down menu 904 allows the manager 30 to select which marketing campaign template 260 he/she wants to generate, e.g., direct mail marketing campaign 270a, email marketing campaign 270b, phone call marketing campaign 270c, flyer marketing campaign 270d, and survey marketing campaign 270e. A text box 906 allows the manager 30 to add any additional comments. In some examples, the screen 900 includes a subject line box 908 and a description box 910 allowing the manager 30 to enter text in either boxes. When the manager 30 is generating an email marketing campaign 270b, the manager 30 may upload an html file in the upload text box 912. In some examples, the manager 30 selects to also create a flyer marketing campaign 270d based on the entered information, see drop down menu 914. If so, the manager 30 may also upload an html flyer in the html box 916. In some examples, the manager 30 specifies a theme for the flyer marketing campaign 270d in the text box 918, and adds a custom message within the flyer in the text box 920. Finally, the manager 30 may either select a cancel button 922 to cancel the changes or select an apply changes button 924 to apply the changes made and save the templates generated.

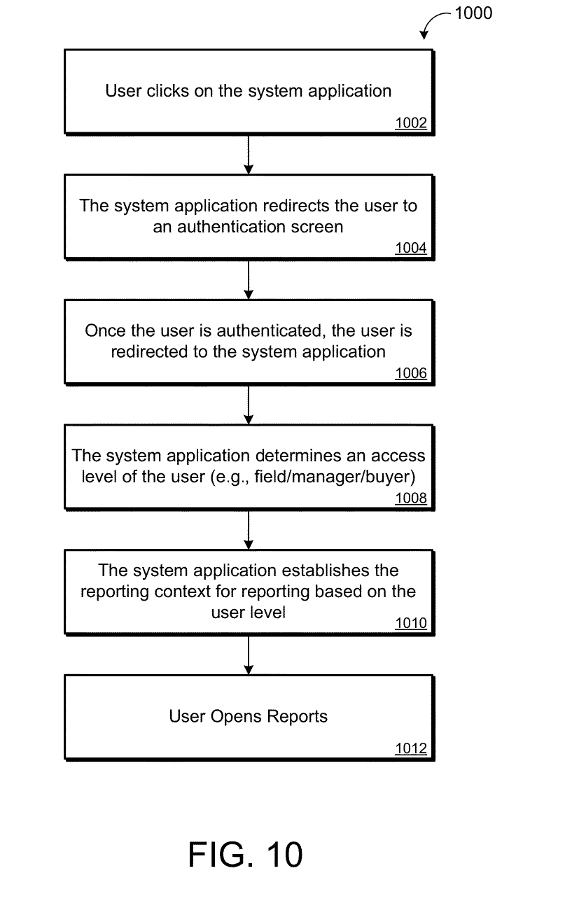

FIG. 10 provides an example arrangement of operations for a process 1000 of user authentication. At block 1002, a user 20, 30 initiates the system application 114, 204 executing on the system 100. At block 1004, the system application 114, 204 redirects the user 20, 30 to an authentication screen displayed on a display 26, 116, 206. At block 1006, and after the user 20, 30 enters his username and password and both are authenticated, the user 20, 30 is then redirected to the system application 114. At block 1008, the system application 114 determines an access level of the user 20, 30 (e.g., seller 20, corporate manager 30, field manager 30). At block 1010, the system application 114 determines the reports 152 based on the user type. Finally, at block 1012, the system application 114 makes available to the user 20, 30 the reports 152 associated with the user's authentication level.

In some implementations, once the system 100 authenticates a user 20, 30 and determines the access level of the user 20, 30, the system 100 displays on a display 26, 116, 206 a main screen (not shown). The main screen may display a custom menu that allows the user 20, 30 to select which advertisement campaign to generate, update, or sent. In some implementations, the user 20, 30 a list of the available reports 154 are available for the user 20, 30 to select and view. Once the user 20, 30 selects the report 152 that he or she wants to view, the report 152 is displayed as on the display 26, 116, 206.

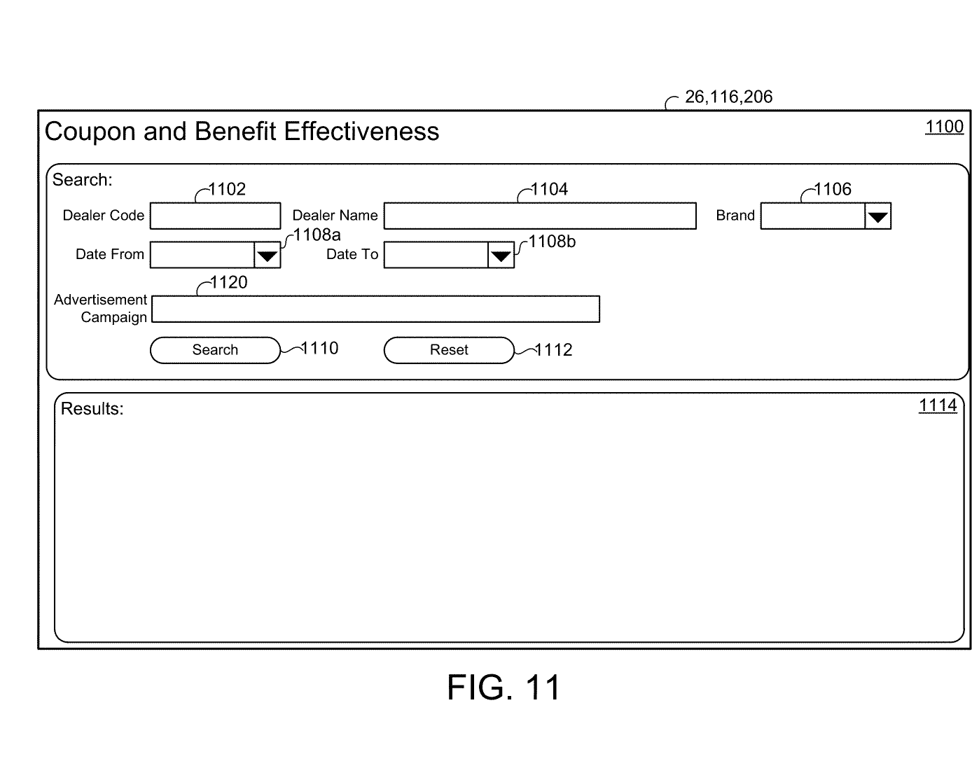

FIG. 11 illustrates an exemplary displayable customer management view 1100 for viewing the reports 152 of the effectiveness of the marketing campaigns 260. The user 20, 30 may select specific metrics to view results 1114 associated with the metrics. The manager 30 enters information via a seller interface, and the segmenter 140 retrieves information, i.e., the segmentation criteria 142, entered by the manager 30 and segments the stored customer records 122 (of one or more seller record(s) 220) based on the segmentation criteria 142. Customer records 122 include customer information such as the customer's address, name, email address, transactions with the seller 20, and any relevant information. In addition, each customer record 122 is associated with one customer 10. Then the reporter 150 reports the stored customer records 122 back to the seller 20 based on the segmentation criteria 142 entered by the manager 30. The customer management view 1100 includes a seller code input field 1102 and a seller name field 1104. The seller code or seller ID is an identification number identifying the seller 20.

In some examples, the customer management view 1100 includes a brand field 1106, which allows the manager 30 to further narrow the segmentation criteria 142 entered resulting in a narrower search result 1114. For example, if the seller 20 is a car dealer, the seller 20 might be selling parts related to multiple car brands. Therefore, the brand field 1106 allows the manager 30 to narrow their search of marketing campaign 260 effectiveness based on specific car brands. The customer management view 1100 may also include date range fields 1108, 1108a, 1108b, which allows the manager 30 to enter a date range e.g., start date 1108a and end date 1108b, and further narrow the search results 1114. Moreover, the user 20, 30 may search based on a specific marketing campaign 260 that was sent out to the customers by selecting a marketing campaign 260 in the text box 1120. In some examples, the user 20, 30 selects more than one marketing campaign 260. The seller 20 or manager 30 selects a search button 1110, allowing the segmenter 140 to segment the stored customer records 122 organized in tables, which when completed are displayed on the display 26, 116, 206. Once the seller or manager 30 selects the search button 1110, a result set 1114 appears on the display 26, 116, 206. The search results 1114 include information related to the customers 10 and the sellers 20. The result set 1114 may include a current date, brand, total sales by the seller 20 generated by the marketing campaign 260, customer account, and other information pertaining to transactions between the seller 20 and the customer 10 that is due to the marketing campaign 260. The seller 20 or manager 30 may also select a reset button 1112 that clears the entered information, allowing the seller 20 or manager 30 to reenter that information.

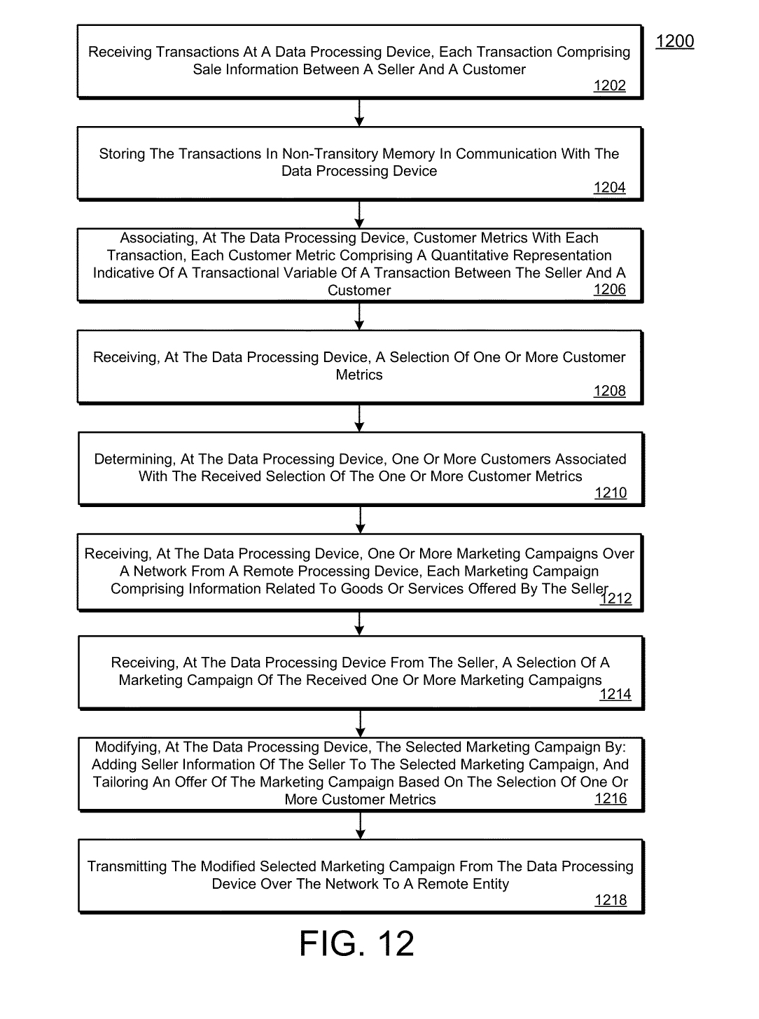

FIG. 12 illustrates an example arrangement of operations for a method 1200 of market management, for example, using the marketing management system 100. At block 1202, the method 1200 includes receiving transactions 210 at a data processing device 200. Each transaction 210 includes sale information between a seller 20 and a customer 10. At block 1204, the method 1200 includes storing the transactions 210 in non-transitory memory 202 in communication with the data processing device 110, 200. At block 1206, the method 1200 includes associating, at the data processing device 200, customer metrics (e.g., segmentation criteria 142) with each transaction 210. Each customer metric (e.g., segmentation criteria 142) includes a quantitative representation indicative of a transactional variable of a transaction 210 between the seller 20 and a customer 10. At block 1208, the method 1200 includes receiving, at the processing device 200, a selection of one or more customer metrics (e.g., segmentation criteria 142); and at block 1210, the method 1200 includes determining, at the data processing device 200, one or more customers 10 associated with the received selection of the one or more customer metrics (e.g., segmentation criteria 142). At block 1212, the method 1200 includes receiving, at the data processing device 200, one or more marketing campaigns 260 over a network from a remote processing device 110 (e.g., a seller processing device 110); each marketing campaign 260 includes information related to goods 31 or services offered by the seller 20. At block 1214, the method 1200 includes receiving, at the data processing device 200 from the seller 20, a selection of a marketing campaign 260 of the received one or more marketing campaigns 260. At block 1216, the method 1200 includes modifying, at the data processing device 200, the selected marketing campaign 260 by adding seller information of the seller 20 to the selected marketing campaign 260 and tailoring an offer of the marketing campaign 260 based on the selection of the one or more customer metrics. At block 1218, the method 1200 includes transmitting the modified selected marketing campaign 260 from the data processing device 200 over the network 15 to a remote entity (e.g., an email server sending emails to customers 10 or a third party that prints the modified selected marketing campaign 260 and distributes it to the customers 10).

In some implementations, the customer metrics (e.g., segmentation criteria 142) include at least one of a customer name, a customer address, customer information, a customer type, a customer status 146, or a transaction type. The customer status 146 may include an active status 146a, an inactive status 146b, or a prospective status 146c. The active status 146a corresponds to a customer 10 having an active associated purchase history within a first threshold period of time. The inactive status 146b corresponds to a customer 10 having an inactive associated purchase history for the first threshold period of time, and the prospective status 146c corresponds to a customer 10 having no associated purchase history. Each transaction 210 may include information of at least one of a service or merchandise of the seller to a customer 10. One or more marketing campaigns 260 may include at least one of a direct mail marketing campaign 270a, an email marketing campaign 270b, a phone call marketing campaign 270c, a flyer marketing campaign 270d, or a survey marketing campaign 270 e. The seller information may include at least one of a seller name, a seller logo, an image, a coupon 268, an offer, or text information.

In some examples, the method 1200 includes generating a report 220 based on the customer metrics and the modified selected marketing campaign 260 transmitted from the data processing device 110 over the network 15 to the remote entity. Generating the report 220 may include generating and displaying on an electronic display 26, 116, 206 in communication with the data processing device 200 an interactive report 152 that provides cascading information for a customer type, a customer status 146, and the selected marketing campaign 260. Generating the report may further include generating a table or graphical illustration illustrating a sales trend over a period of time based on the selected marketing campaign 260. The method 1200 may further include receiving, at the data processing device 110 over the network 15 from the remote entity, customer feedback associated with the selected marketing campaign 260.

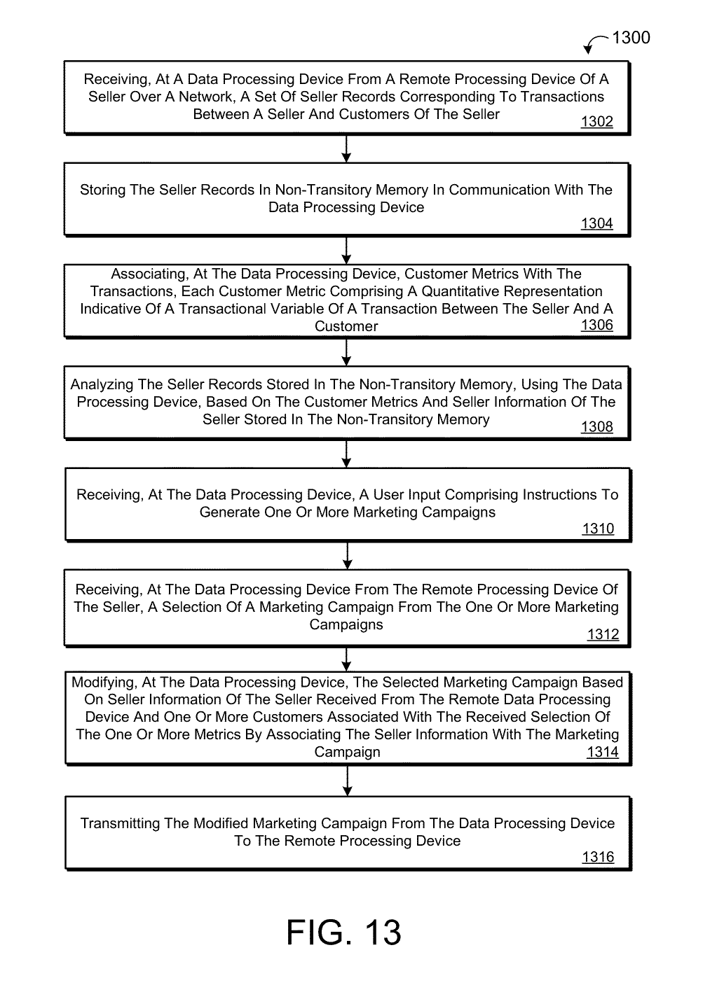

FIG. 13 illustrates an example arrangement of operations for a method 1300 of marketing management, e.g., using the marketing management system 100. At block 1302, the method 1300 includes receiving, at a data processing device 110 from a remote processing device a set of seller records corresponding to transactions between a seller 20 and customers 10 of the seller 20. At block 1304, the method 1300 includes storing the seller records 220 in non-transitory memory 112 in communication with the data processing device 110. At block 1306, the method 1300 includes associating, at the data processing device 110, customer metrics with the transactions, each customer metric including a quantitative representation indicative of a transactional variable of a transaction between the seller 20 and a customer 10. At block 1308, the method 1300 includes analyzing the seller records 220 stored in the non-transitory memory 112, using the data processing device 110, based on the customer metrics and seller information of the seller 20 stored in the non-transitory memory 112. At block 1310, the method 1300 includes receiving, at the data processing device 110, a user input including instructions to generate one or more marketing campaigns 260. At block 1312, the method 1300 includes receiving, at the data processing device 110 from the remote processing device of the seller 20, a selection of a marketing campaign 260 from the one or more marketing campaigns 260. At block 1314, the method 1300 includes modifying, at the data processing device 110, the selected marketing campaign 260 based on seller information of the seller 20 received from the remote data processing device and one or more customers 10 associated with the received selection of the one or more metrics by associating the seller information with the marketing campaign 260. At block 1316, the method 1300 further includes transmitting the modified marketing campaign 260 from the data processing device 110 to the remote processing device.

In some examples, the customer metrics include at least one of a customer name, a customer address, customer information, a customer type, a customer status 146, or a transaction type. The customer status 146 includes an active status 146a, an inactive status 146b, or a prospective status 146c. The active status 146a corresponds to a customer 10 having an active associated purchase history within a first threshold period of time, the inactive status 146b corresponds to a customer 10 having an inactive associated purchase history for the first threshold period of time, and the prospective status 146c corresponds to a customer 10 having no associated purchase history. Each transaction may include information of at least one of a service or merchandise 31 of the seller 20 to a customer 10. One or more of the marketing campaigns 260 may include at least one of a direct mail marketing campaign 270a, an email marketing campaign 270b, a phone call marketing campaign 270c, a flyer marketing campaign 270d, or a survey marketing campaign 270e. The seller information may include at least one of a seller name, a seller logo, an image, a coupon, an offer, or text information.

The method 1300 may further include generating a report 220 based on the customer metrics and the modified selected marketing campaign 260. Generating the report 220 may include generating and displaying on an electronic display 26, 116, 206 in communication with the data processing device 110 an interactive report 152 that provides cascading information for a customer type, a customer status 146, and the selected marketing campaign 260. The method 1300 may further include receiving, at the data processing device 110 over the network 15 from the remote processing device of the seller 20, customer feedback associated with the selected marketing campaign 260.

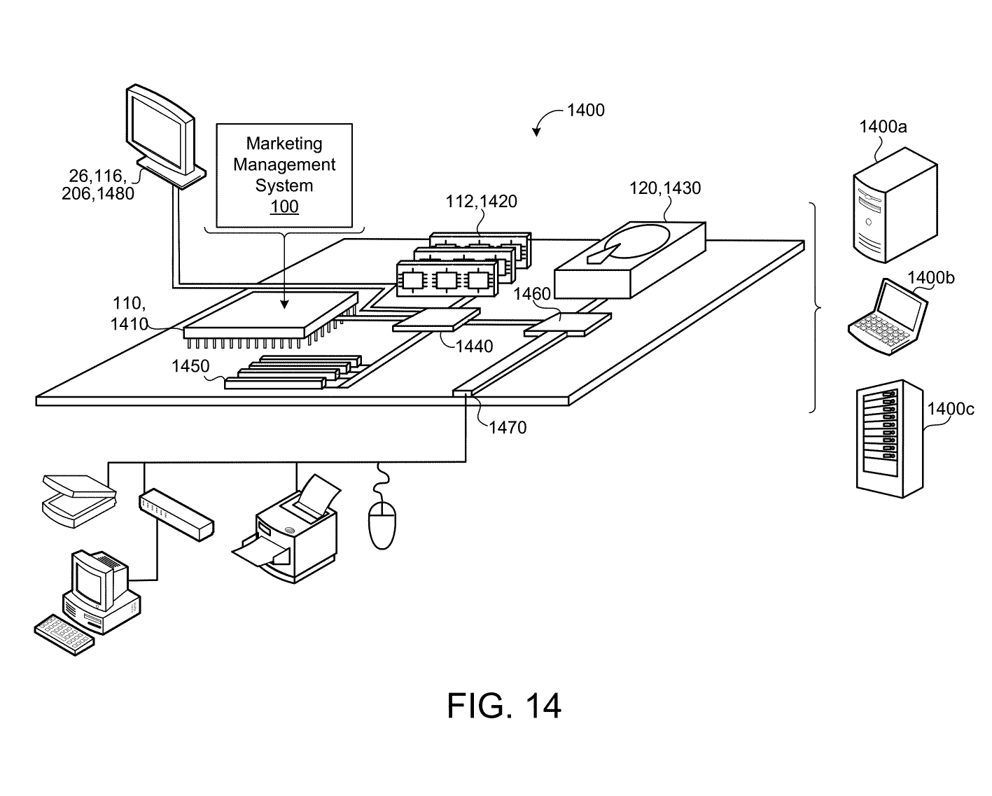

FIG. 14 is a schematic view of an example computing device 1400 that may be used to implement the systems and methods described in this document. The computing device 1400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1400 includes a processor 1410, memory 1420, a storage device 1430, a high-speed interface/controller 1440 connecting to the memory 1420 and high-speed expansion ports 1450, and a low speed interface/controller 1460 connecting to the low speed bus 1470 and storage device 1430. Each of the components 1410, 1420, 1430, 1440, 1450, and 1460, are interconnected using various busses, and may be mounted on a common motherboard or in other manners as appropriate. The processor 1410 can process instructions for execution within the computing device 1400, including instructions stored in the memory 112, 1420 or on the storage device 120, 1430 to display graphical information for a graphical user interface (GUI) on an external input/output device, such as a display 1480 coupled to a high speed interface 1440. In other implementations, multiple processors and/or multiple buses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 112, 1420 stores information non-transitorily within the computing device 1400. The memory 1420 may be a computer-readable medium, a volatile memory unit(s), or non-volatile memory unit(s). The non-transitory memory 1420 may be physical devices used to store programs (e.g., sequences of instructions) or data (e.g., program state information) on a temporary or permanent basis for use by the computing device 1400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 120, 1430 is capable of providing mass storage for the computing device 1400. In some implementations, the storage device 120, 1430 is a computer-readable medium. In various different implementations, the storage device 120, 1430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 112, 1420, the storage device 120, 1430, or memory on processor 110, 1410.

The high speed controller 1440 manages bandwidth-intensive operations for the computing device 1400, while the low speed controller 1460 manages lower bandwidth-intensive operations. Such allocation of duties is exemplary only. In some implementations, the high-speed controller 1440 is coupled to the memory 1420, the display 1480 (e.g., through a graphics processor or accelerator), and to the high-speed expansion ports 1450, which may accept various expansion cards (not shown). In some implementations, the low-speed controller 1460 is coupled to the storage device 1430 and low-speed expansion port 1470. The low-speed expansion port 1470, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1400 may be implemented in a number of different forms, as shown in FIG. 14. For example, it may be implemented as a standard server 1400 or multiple times in a group of such servers 1400a, as a laptop computer 1400b, or as part of a rack server system 1400c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving transactions at a data processing device, each transaction comprising sale information between a seller and a customer;
storing the transactions in non-transitory memory in communication with the data processing device;
associating, at the data processing device, customer metrics with each transaction, each customer metric comprising a quantitative representation indicative of a transactional variable of a transaction between the seller and a customer;
receiving, at the data processing device, a selection of one or more customer metrics;
determining, at the data processing device, one or more customers associated with the received selection of the one or more customer metrics;
receiving, at the data processing device, one or more marketing campaigns over a network from a remote processing device, each marketing campaign comprising information related to goods or services offered by the seller;
receiving, at the data processing device from the seller, a selection of a marketing campaign of the received one or more marketing campaigns;
modifying, at the data processing device, the selected marketing campaign by:
adding seller information of the seller to the selected marketing campaign; and
tailoring an offer of the marketing campaign based on the selection of the one or more customer metrics; and
transmitting the modified selected marketing campaign from the data processing device over the network to a remote entity.

2. The method of claim 1, wherein the customer metrics comprise at least one of a customer name, a customer address, customer information, a customer type, a customer status, or a transaction type.

3. The method of claim 2, wherein the customer status comprises an active status, an inactive status, or a prospective status, the active status corresponding to a customer having an active associated purchase history within a first threshold period of time, the inactive status corresponding to a customer having an inactive associated purchase history for the first threshold period of time, and the prospective status corresponding to a customer having no associated purchase history.

4. The method of claim 1, wherein each transaction comprises information of at least one of a service or merchandise of the seller to a customer.

5. The method of claim 1, wherein the one or more marketing campaigns comprises at least one of a direct mail marketing campaign, an email marketing campaign, a phone call marketing campaign, a flyer marketing campaign, or a survey marketing campaign.

6. The method of claim 1, wherein the seller information comprises at least one of a seller name, a seller logo, an image, a coupon, an offer, or text information.

7. The method of claim 1, further comprising generating a report based on the customer metrics and the modified selected marketing campaign transmitted from the data processing device over the network to the remote entity.

8. The method of claim 7, wherein generating the report comprises generating and displaying on an electronic display in communication with the data processing device an interactive report that provides cascading information for a customer type, a customer status, and the selected marketing campaign.

9. The method of claim 7, wherein generating the report comprises generating a table or graphical illustration illustrating a sales trend over a period of time based on the selected marketing campaign.

10. The method of claim 1, further comprising receiving, at the data processing device over the network from the remote entity, customer feedback associated with the selected marketing campaign.

11. A user device comprising:
a display;
a computing device in communication with the display; and
non-transitory memory in communication with the computing device, the non-transitory memory storing instruction that when executed on the computing device cause the computing device to perform operations comprising:
receiving transactions at a data processing device, each transaction comprising sale information between a seller and a customer;
storing the transactions in non-transitory memory in communication with the data processing device;
associating, at the data processing device, customer metrics with each transaction, each customer metric comprising a quantitative representation indicative of a transactional variable of a transaction between the seller and a customer;
receiving, at the data processing device, a selection of one or more customer metrics;
determining, at the data processing device, one or more customers associated with the received selection of the one or more customer metrics;
receiving, at the data processing device, one or more marketing campaigns over a network from a remote processing device, each marketing campaign comprising information related to goods or services offered by the seller;
receiving, at the data processing device from the seller, a selection of a marketing campaign of the received one or more marketing campaigns;
modifying, at the data processing device, the selected marketing campaign by:
adding seller information of the seller to the selected marketing campaign; and
tailoring an offer of the marketing campaign based on the selection of the one or more customer metrics; and
transmitting the modified selected marketing campaign from the data processing device over the network to a remote entity.

12. The user device of claim 11, wherein the customer metrics comprise at least one of a customer name, a customer address, customer information, a customer type, a customer status, or a transaction type.

13. The user device of claim 12, wherein the customer status comprises an active status, an inactive status, or a prospective status, the active status corresponding to a customer having an active associated purchase history within a first threshold period of time, the inactive status corresponding to a customer having an inactive associated purchase history for the first threshold period of time, and the prospective status corresponding to a customer having no associated purchase history.

14. The user device of claim 11, wherein each transaction comprises information of at least one of a service or merchandise of the seller to a customer.

15. The user device of claim 11, wherein the one or more marketing campaigns comprises at least one of a direct mail marketing campaign, an email marketing campaign, a phone call marketing campaign, a flyer marketing campaign, or a survey marketing campaign.

16. The user device of claim 11, wherein the seller information comprises at least one of a seller name, a seller logo, an image, a coupon, an offer, or text information.

17. The user device of claim 11, wherein the operations further comprise generating a report based on the customer metrics and the modified selected marketing campaign transmitted from the data processing device over the network to the remote entity.

18. The user device of claim 17, wherein generating the report comprises generating and displaying on an electronic display in communication with the data processing device an interactive report that provides cascading information for a customer type, a customer status, and the selected marketing campaign.

19. The user device of claim 17, wherein generating the report comprises generating a table or graphical illustration illustrating a sales trend over a period of time based on the selected marketing campaign.

20. The user device of claim 11, wherein the operations further comprise receiving, at the data processing device over the network from the remote entity, customer feedback associated with the selected marketing campaign.

21. A method comprising:
receiving, at a data processing device from a remote processing device of a seller over a network, a set of seller records corresponding to transactions between a seller and customers of the seller;
storing the seller records in non-transitory memory in communication with the data processing device;
associating, at the data processing device, customer metrics with the transactions, each customer metric comprising a quantitative representation indicative of a transactional variable of a transaction between the seller and a customer;
analyzing the seller records stored in the non-transitory memory, using the data processing device, based on the customer metrics and seller information of the seller stored in the non-transitory memory;
receiving, at the data processing device, a user input comprising instructions to generate one or more marketing campaigns;
receiving, at the data processing device from the remote processing device of the seller, a selection of a marketing campaign from the one or more marketing campaigns;
modifying, at the data processing device, the selected marketing campaign based on seller information of the seller received from the remote data processing device and one or more customers associated with the received selection of the one or more metrics by associating the seller information with the marketing campaign; and
transmitting the modified marketing campaign from the data processing device to the remote processing device.

22. The method of claim 21, wherein the customer metrics comprise at least one of a customer name, a customer address, customer information, a customer type, a customer status, or a transaction type.

23. The method of claim 22, wherein the customer status comprises an active status, an inactive status, or a prospective status, the active status corresponding to a customer having an active associated purchase history within a first threshold period of time, the inactive status corresponding to a customer having an inactive associated purchase history for the first threshold period of time, and the prospective status corresponding to a customer having no associated purchase history.

24. The method of claim 21, wherein each transaction comprises information of at least one of a service or merchandise of the seller to a customer.

25. The method of claim 21, wherein the one or more marketing campaigns comprises at least one of a direct mail marketing campaign, an email marketing campaign, a phone call marketing campaign, a flyer marketing campaign, or a survey marketing campaign.

26. The method of claim 21, wherein the seller information comprises at least one of a seller name, a seller logo, an image, a coupon, an offer, or text information.

27. The method of claim 21, further comprising generating a report based on the customer metrics and the modified selected marketing campaign.

28. The method of claim 27, wherein generating the report comprises generating and displaying on an electronic display in communication with the data processing device an interactive report that provides cascading information for a customer type, a customer status, and the selected marketing campaign.

29. The method of claim 27, wherein generating the report comprises generating a table or graphical illustration illustrating a sales trend over a period of time based on the selected marketing campaign.

30. The method of claim 21, further comprising receiving, at the data processing device over the network from the remote processing device of the seller, customer feedback associated with the selected marketing campaign.

31. A system comprising:
a display;
a computing device in communication with the display; and
non-transitory memory in communication with the computing device, the non-transitory memory storing instruction that when executed on the computing device cause the computing device to perform operations comprising:
receiving, at a data processing device from a remote processing device of a seller over a network, a set of seller records corresponding to transactions between a seller and customers of the seller;
storing the seller records in non-transitory memory in communication with the data processing device;
associating, at the data processing device, customer metrics with the transactions, each customer metric comprising a quantitative representation indicative of a transactional variable of a transaction between the seller and a customer;
analyzing the seller records stored in the non-transitory memory, using the data processing device, based on the customer metrics and seller information of the seller stored in the non-transitory memory;
receiving, at the data processing device, a user input comprising instructions to generate one or more marketing campaigns;
receiving, at the data processing device from the remote processing device of the seller, a selection of a marketing campaign from the one or more marketing campaigns;
modifying, at the data processing device, the selected marketing campaign based on seller information of the seller received from the remote data processing device and one or more customers associated with the received selection of the one or more metrics by associating the seller information with the marketing campaign; and
transmitting the modified marketing campaign from the data processing device to the remote processing device.

32. The system of claim 31, wherein the customer metrics comprise at least one of a customer name, a customer address, customer information, a customer type, a customer status, or a transaction type.

33. The system of claim 32, wherein the customer status comprises an active status, an inactive status, or a prospective status, the active status corresponding to a customer having an active associated purchase history within a first threshold period of time, the inactive status corresponding to a customer having an inactive associated purchase history for the first threshold period of time, and the prospective status corresponding to a customer having no associated purchase history.

34. The system of claim 31, wherein each transaction comprises information of at least one of a service or merchandise of the seller to a customer.

35. The system of claim 31, wherein the one or more marketing campaigns comprises at least one of a direct mail marketing campaign, an email marketing campaign, a phone call marketing campaign, a flyer marketing campaign, or a survey marketing campaign.

36. The system of claim 31, wherein the seller information comprises at least one of a seller name, a seller logo, an image, a coupon, an offer, or text information.

37. The system of claim 31, wherein the operations further comprise generating a report based on the customer metrics and the modified selected marketing campaign.

38. The system of claim 37, wherein generating the report comprises generating and displaying on an electronic display in communication with the data processing device an interactive report that provides cascading information for a customer type, a customer status, and the selected marketing campaign.

39. The system of claim 37, wherein generating the report comprises generating a table or graphical illustration illustrating a sales trend over a period of time based on the selected marketing campaign.

40. The system of claim 31, wherein the operations further comprise receiving, at the data processing device over the network from the remote processing device of the seller, customer feedback associated with the selected marketing campaign.
